(19) United States
(12) Patent Application Publication
(10) Pub. No.: US 2008/0165009 A1
(43) Pub. Date: Jul. 10, 2008

(54) CONTAINER FOR INCLUDING RFID TAG AND APPARATUS FOR COMMUNICATING WITH AN RFID TAG

(76) Inventor: Mitsuo Hirota, Toyoake-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/972,420

(22) Filed: Jan. 10, 2008

Related U.S. Application Data
(63) Continuation-in-part of application No. PCT/JP2006/313742, filed on Jul. 11, 2006.

(30) Foreign Application Priority Data
Jul. 12, 2005 (JP) 2005202583

(51) Int. Cl. G08B 13/14; B41J 11/44

(52) U.S. Cl. 340/572.1; 400/76

(57) ABSTRACT

A communication distance between a device antenna and a tag antenna is kept substantially constant all the time so that a stable communication range can be obtained and secure and stable communication is performed. A cartridge is provided with a rib contact face to be a positioning reference at attachment, and a cartridge holder portion of an apparatus for communicating with a RFID tag has a positioning pin provided in correspondence with the rib contact face so that even if various cartridges with mutually different tag attribute parameters such as the size of a base tape, an arrangement pitch of a RFID circuit element To and the like are replaced and used appropriately, a distance between a tag antenna and a device antenna is kept substantially constant in cooperation with the positioning pin provided on the side of the apparatus for communicating with a RFID tag corresponding to the rib contact face, regardless of the type of the cartridge.

### CROSS-REFERENCE TO RELATED APPLICATION

This is a CIP application PCT/JP2006/313742, filed Jul. 11, 2006, which was not published under PCT article 21(2) in English and claims the benefits of Japanese Patent application No. 2005-202583 filed Jul. 12, 2005.

### BACKGROUND OF THE INVENTION

1. Field of the Invention

The present invention relates to a container for including RFID tag provided with a RFID circuit element for radio communication of information with outside and an apparatus for communicating with a RFID tag in which the container for including RFID tag is detachably arranged.

2. Description of the Related Art

A RFID (Radio Frequency Identification) system for reading/writing information contactlessly between a small-sized RFID tag and a reader (reading device)/writer (writing device) is known. A RFID circuit element provided at a RFID tag includes an IC circuit part storing predetermined RFID tag information and an antenna connected to the IC circuit part and transmitting/receiving information, and even if the RFID tag is stained or arranged in a hidden position, an access can be made from the side of the reader/writer to the RFID tag information of the IC circuit part (information reading/writing), and practical use in various fields including merchandize control, inspection processes and the like is expected.

Such a RFID tag is usually formed by providing a RFID circuit element on a label-state material, and the tag label is often affixed to a target article or the like for classification/arrangement of documents/articles, for example. It is extremely convenient if character information is printed in addition on the tag itself for management of the RFID tag. Thus, conventionally, an apparatus for communicating with a RFID tag (apparatus for producing RFID label) not only for information reading/writing with respect to a RFID tag but also for printing on the tag has been already proposed.

In an apparatus described in Patent Document 1, for example, a cartridge provided with a roll (supply spool) around which a base tape (band-state tape) with RFID circuit elements (antenna portion and an IC chip) arranged in the tape longitudinal direction with a substantially equal interval is wound is attached to a cartridge holder, which is a recess part of a main body housing, the tag tape is fed out of the roll of this cartridge for transmission/reception of RFID tag information to the RFID circuit element provided at the tag tape, while predetermined print is applied on a predetermined position on a print-receiving tape (laminate) from another roll (tape spool) different from the above roll by a thermal head (printing head), and the tag tape and the print-receiving tape after print are bonded together so that a tag label with print is produced.

[Patent Document 1] JP, A, 2004-330492

With the recent expansion of use of the RFID tag, its application fields are diversified, and RFID labels in various modes according to the application are in demand. For example, by preparing a plurality of cartridges with different base tape widths or the RFID circuit element arrangement intervals and the like in advance and by detaching and replacing the cartridge according to the application, a tag label can be produced with an arrangement mode of the RFID circuit element variously changed.

Here, if cartridges with different base tape widths are used by replacement in order to produce tag labels with various widths, since the above prior art has a structure that a face in the depth (bottom face) in the attachment direction of the cartridge is abutted against the cartridge holder on the apparatus side for attachment, a difference is brought about in a distance between the base tape and the bottom face of the cartridge holder depending on the dimension in the thickness direction of the cartridge (in other words, a tape feeding path is displaced in the tape-width direction). That is, when a cartridge with a small dimension in the thickness direction incorporating a base tape with a relatively narrow width is attached, a distance between the bottom face of the cartridge holder and the center of the base tape in the width-direction becomes relatively small, and the center of the base tape in the feeding path gets relatively closer to the side of the cartridge holder. On the other hand, if a cartridge with a large dimension in the thickness direction incorporating a base tape with a relatively wide width is attached, the distance between the bottom face of the cartridge holder and the center of the base tape in the width-direction becomes relatively large, and the center of the base tape in the feeding path gets relatively far from the side of the cartridge holder.

If the distance between the center of the base tape in the feeding path and the side of the cartridge holder is varied depending on the tape width in use as above, since the device antenna is fixed to a predetermined position on the side of the cartridge holder along the center of the base tape in the feeding path, the distance between the device antenna and a tag antenna of a RFID circuit element provided at the center of the base tape in the width-direction is changed according to the base tape width, which incurs a fear that assured and stable communication with the RFID circuit elements provided at the base tapes with various tape widths might become difficult.

### SUMMARY OF THE INVENTION

The present invention has an object to provide a container for including RFID tag and an apparatus for communicating with a RFID tag capable of assured and stable communication by keeping a distance between a device antenna and a feeding path of a tag antenna substantially constant with respect to various tape widths.

### BRIEF DESCRIPTION OF THE DRAWINGS

FIG. 1 is a system configuration diagram illustrating a RFID tag manufacturing system to which an apparatus for communicating with a RFID tag of a first embodiment of the present invention is applied.

FIG. 2 is a perspective view illustrating an entire schematic structure of the apparatus for communicating with a RFID tag.

FIG. 3 is a perspective view illustrating a casing of a cartridge.

FIG. 4 is a top view of a cartridge holder portion with a cartridge and an opening/closing lid removed from a main body when seen from the IV direction in FIG. 2.

FIG. 5 is a perspective view of the cartridge holder portion with the cartridge and the opening/closing lid removed from the main body when seen from the V direction in FIG. 2.

FIG. 6 is a conceptual configuration diagram illustrating a detailed structure of the apparatus for communicating with a RFID tag.

FIG. 7 is an explanatory diagram for illustrating a detailed structure of the cartridge.

FIG. 8 is a functional block diagram illustrating a detailed function of a radio frequency circuit.

FIG. 9 is a functional block diagram illustrating functional configuration of a RFID circuit element.

FIGS. 10A and 10B are a top view and a bottom view illustrating an example of an appearance of a RFID label.

FIG. 11 is a cross-sectional diagram by an XI-XI′ section in FIG. 10.

FIG. 12 is a view illustrating an example of a screen displayed on a terminal or a general-purpose computer at writing or reading of RFID tag information.

FIGS. 13A and 13B are views illustrating a comparative example in which a cartridge not provided with a positioning rib is directly placed on a cartridge holder portion not provided with a positioning pin.

FIGS. 14A and 14B are views illustrating a supported state of the positioning rib by the positioning pin when the cartridge is attached to the cartridge holder portion.

FIG. 15 is a flowchart illustrating a control procedure executed by a control circuit shown in FIG. 6.

FIG. 16 is a flowchart illustrating a detailed procedure of Step S200 in FIG. 15.

FIGS. 17A and 17B are views illustrating a supported state of a positioning reference portion by a positioning support member when the cartridge is attached to the cartridge holder portion in a variation provided with two types of combinations of the corresponding positioning reference portion and the positioning support member.

FIG. 18 is a flowchart illustrating a RFID tag information reading procedure executed by the control circuit.

FIG. 19 is a perspective view illustrating schematic configuration of an apparatus for communicating with a RFID tag of a second embodiment.

FIG. 20 is a perspective view illustrating a state where an upper cover of the apparatus for communicating with a RFID tag shown in FIG. 19 is removed.

FIG. 21 is a side view of a structure shown in FIG. 20.

FIG. 22 is a sectional view by an XXII-XXII′ section in FIG. 21.

FIG. 23A is a perspective view illustrating a state where the upper cover and a tag tape roll are removed from the apparatus for manufacturing RFID label shown in FIG. 19 and FIG. 23B is an enlarged perspective view of a W part in FIG. 23A.

FIG. 24 is a rear perspective view illustrating a state where the upper cover and the tag tape roll of the apparatus for communicating with a RFID tag shown in FIG. 19 are removed.

FIG. 25 is a side sectional view illustrating a state where a tape holder is attached to the apparatus for communicating with a RFID tag shown in FIG. 19 with the upper cover removed.

FIG. 26 is a conceptual diagram illustrating a control system of the apparatus for communicating with a RFID tag.

FIGS. 27A and 27B are a perspective view from upper front and a perspective view from lower rear illustrating a detailed structure of a tag tape roll body provided at the apparatus for communicating with a RFID tag shown in FIG. 19.

FIGS. 28A and 28B are a perspective view from diagonally rear and a perspective view from diagonally front of the tape holder.

FIGS. 29A to 29C are a left side view, a front view and a right side view illustrating the detailed structure of the tape holder.

FIG. 30 is a sectional view on arrow in a Y-Y′ section in FIG. 29A.

FIG. 31 is a sectional view on arrow in a Z-Z′ section in FIG. 29A.

FIGS. 32A to 32E are views illustrating drilling examples of sensor holes indicating a type of the tag tape at a tape discriminating portion of a holder holding member.

FIGS. 33A and 33B are explanatory views for illustrating an example of an attachment behavior of the tape holder to the side of the apparatus for communicating with a RFID tag.

FIGS. 34A and 34B are views illustrating a contact state between a holder positioning rod and a contact bottom face when the tag tape roll body is attached to a containing portion for tape holder.

FIGS. 35A and 35B are views illustrating a contact state between the holder positioning rod and the contact bottom face when the tag tape roll body is attached to a containing portion for tape holder in a variation provided with two types of combinations of the corresponding contact bottom face and the holder positioning rod.

### DETAILED DESCRIPTION OF THE PREFERRED EMBODIMENTS

A first embodiment of the present invention will be described below referring to the attached drawings.

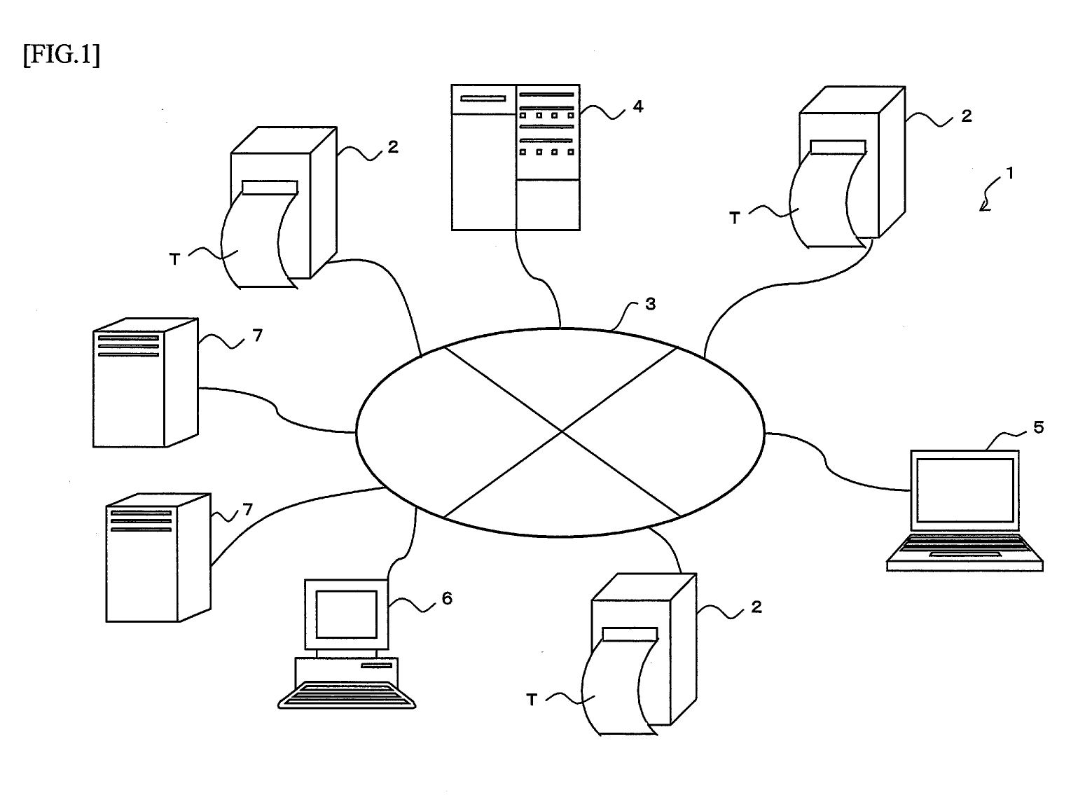

FIG. 1 is a system configuration diagram illustrating a RFID tag manufacturing system to which an apparatus for communicating with a RFID tag of the present embodiment is applied.

In a RFID tag manufacturing system 1 shown in FIG. 1, an apparatus 2 for communicating with a RFID tag according to the present embodiment is connected to a route server 4, a terminal 5, a general-purpose computer 6, and a plurality of information servers 7 via a wired or radio communication line 3.

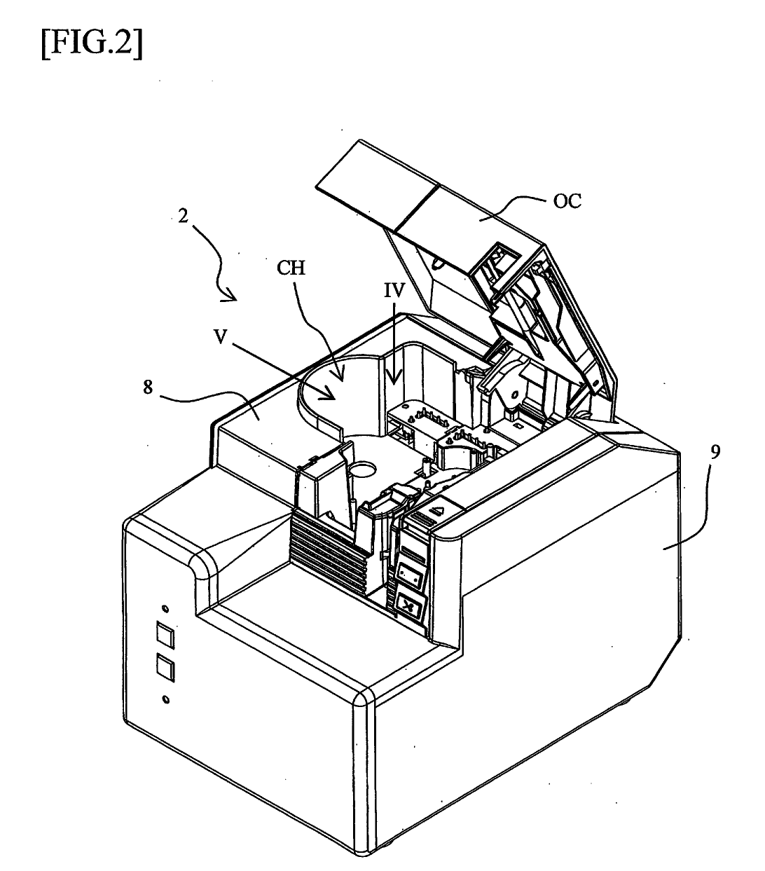

FIG. 2 is a perspective view illustrating an entire schematic structure of the apparatus 2 for communicating with a RFID tag of this embodiment (however, a cartridge 100, which will be described later, is removed and moreover, an opening/closing lid OC is opened).

In FIG. 2, the apparatus 2 for communicating with a RFID tag includes a main body 8, a cartridge holder portion (holder for installing container, cartridge holder) CH that contains a cartridge (container for including RFID tag, RFID tag cartridge) 100, not shown, detachably attached to the main body 8, a housing 9 constituting an outline of the main body 8, and the opening/closing lid OC rotatably connected to the main body 8 so as to cover the cartridge holder portion CH in the closed state.

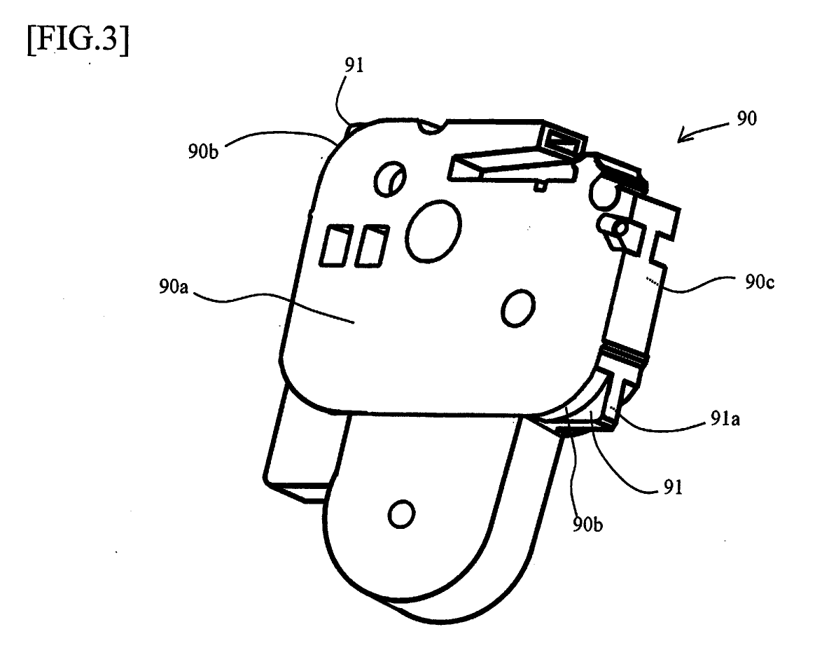

FIG. 3 is a perspective view illustrating only a casing of the cartridge. In FIG. 3, only the casing 90 constituting the housing in the cartridge 100 is shown, and a base tape, an ink ribbon and a print-receiving tape, which will be described later, fed out from inside are not shown.

In FIG. 3, the casing 90 of the cartridge schematically has a substantially semi-circular projection portion provided at the lower part of a substantially rectangular solid in the figure and is formed substantially in a flat plate state with the depth direction in the figure as the thickness direction. Large rounds 90b are formed at two corner parts (corner parts at the upper left and lower right in the figure) on a diagonal line of the substantially rectangular solid when seen from the flat plate face side, and a positioning rib 90 with a thickness smaller than that of a casing body 90a is formed so as to project to the side at the middle position of each round 90b in the thickness direction. Further, on a face (back face in the figure) facing the bottom face of the cartridge holder portion CH in each positioning rib 91, a flat rib contact face (positioning reference portion) 91a located on the same plane is formed, respectively.

In addition, though not particularly shown, a plurality of types of cartridges with different thicknesses of the casing body 90a is provided according to variation of the base tape width provided inside the cartridge 100 (the detail will be described later), and they can be replaced and attached to the cartridge holder portion CH as appropriate according to the use purpose.

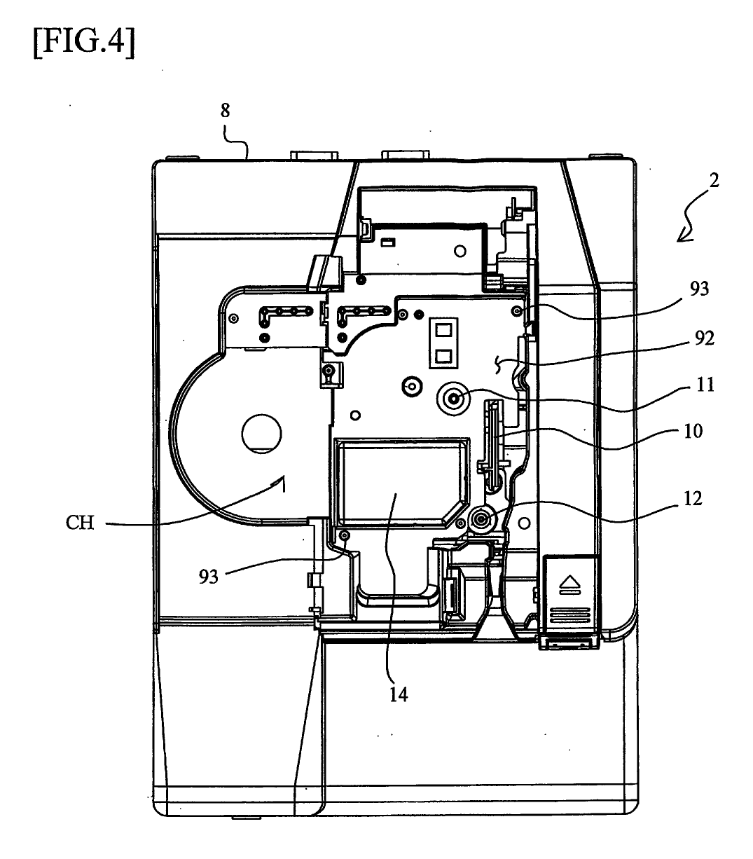

FIG. 4 is a top view of the cartridge holder portion CH in which the cartridge 100 and the opening/closing lid OC are removed from the main body 8 when seen from the IV direction in FIG. 2.

In FIG. 4, the cartridge holder portion CH is provided as a recess where the cartridge 100 can be detachably fitted in the main body 8, and on a holder bottom face 92 located at the bottom, a print head 10, a ribbon take-up roller drive shaft 11, a tape-feeding-roller drive shaft 12, an antenna 14 and the like are provided. Further, at two corner portions corresponding to arrangement of the two positioning ribs 91 when the cartridge 100 is mounted, positioning pins (positioning support members, projections) 93 with the same height are projected.

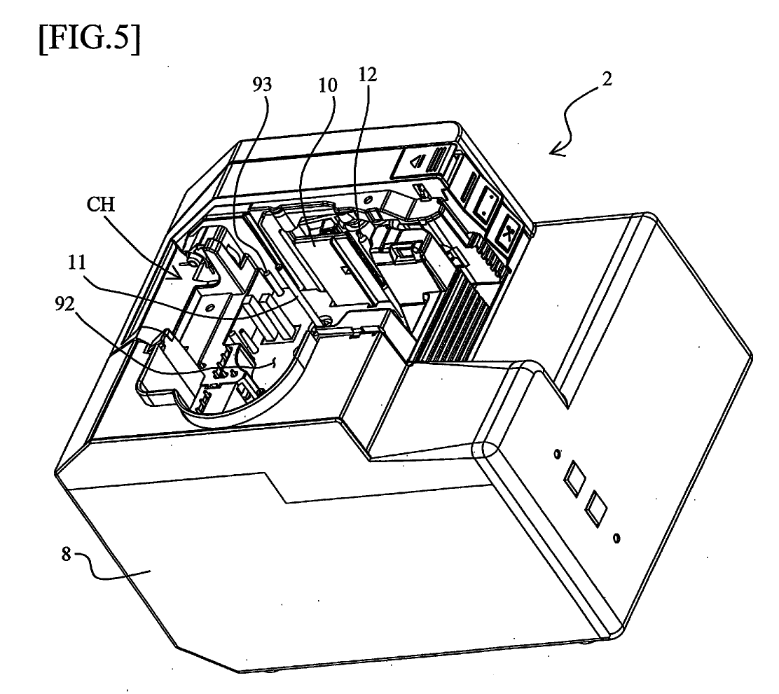

FIG. 5 is a perspective view of the cartridge holder portion CH in a state where the cartridge 100 and the opening/closing lid OC are removed from the main body 8 when seen from the V direction in FIG. 2.

In FIG. 5, the positioning pins 93 (only one of them is shown in FIG. 5) are erected perpendicularly from the holder bottom face 92, and when the cartridge 100 is attached to the cartridge holder portion CH, tip ends of the positioning pins 93 are brought into contact with the rib contact faces 91a of the positioning ribs 91, respectively, so as to support the cartridge 100 (the details will be described later). Thus, the height of the positioning pin 93 is formed with a dimension larger than a distance from the rib contact fact 91a of the cartridge 100 to be mounted to a casing bottom face 90c (back face in the figure).

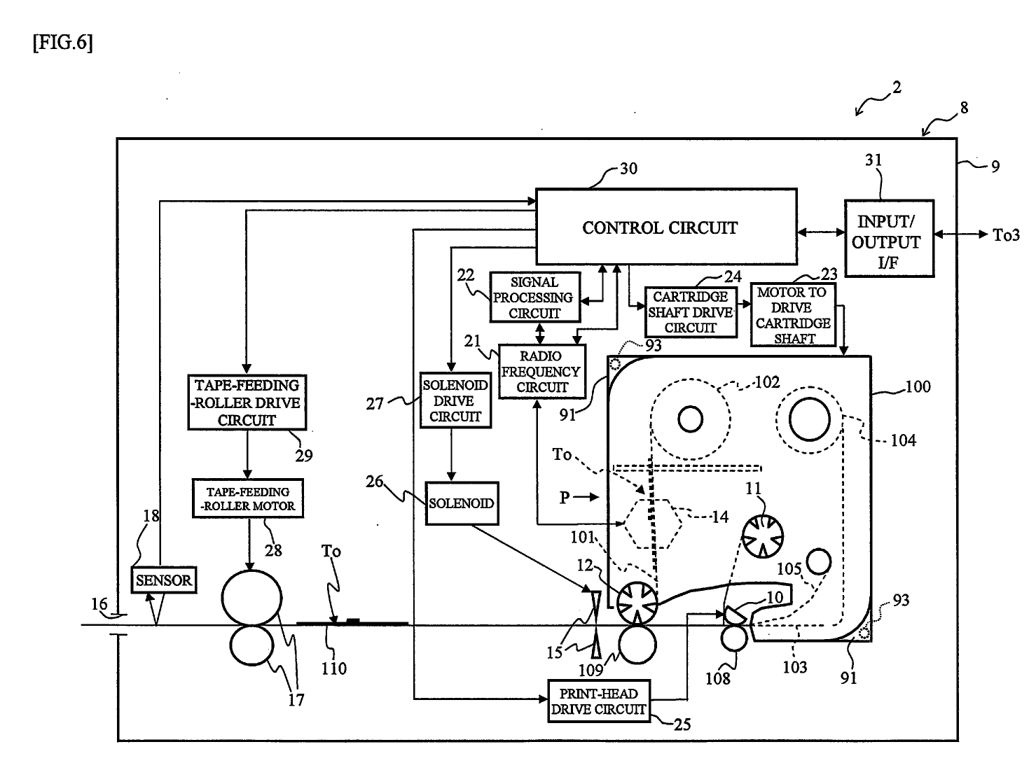

FIG. 6 is a conceptual configuration diagram illustrating a detailed structure of the apparatus 2 for communicating with a RFID tag.

In FIG. 6, the main body 8 of the apparatus 2 for communicating with a RFID tag includes in the housing 9, a print head (printing means, thermal head) 10 that applies a predetermined print (printing) on a print-receiving tape 103 fed out of the second roll (print-receiving tape roll) 104, the ribbon take-up roller drive shaft 11 that drives the ink ribbon 105 which has finished printing on the print-receiving tape 103, the tape-feeding-roller drive shaft 12 that bonds the print-receiving tape 103 and a base tape (tag medium, tag tape) 101 fed out of a first roll (tag tape roll) 102 together and feeds it as a tag label tape 110 with print from the cartridge 100, the antenna (device antenna) 14 that transmits/receives a signal by radio communication using a radio frequency such as an UHF band with a RFID circuit element To (details will be described later) provided at the tag label tape 110 with print, a cutter 15 that cuts the tag label tape 110 with print to a predetermined length at predetermined timing and produces a label-state RFID label T (details will be described later), and a feeding roller 17 that feeds and sends out the RFID label T to a carry-out exit 16.

The antenna 14 includes a directional antenna (plane antenna in this example, or in more detail, a so-called patch antenna) provided with a directivity on one side (front side from the paper face in FIG. 6 in this example), and more specifically, it is a micro-strip antenna provided with a micro-strip antenna element on the inner side of the device and a base plate on the surface side. Also, the antenna 14 is embedded in the vicinity of a feeding path in a plane (orthogonal plane in this example; however, not limited to that, it may be a crossing angle of 45°, 60° and the like other than 90°) crossing a tape face of the feeding path of the base tape 101 fed out of the first roll 102 (distance from the feeding-out position from the roll to the tape-feeding-roller drive shaft 12) so that the base plate is exposed on the holder bottom face 92.

On the other hand, the main body 8 has a radio frequency circuit 21 that accesses (for writing or reading) the RFID circuit element To via the antenna 14, a signal processing circuit 22 for processing of a signal read out from the RFID circuit element To, a motor 23 to drive cartridge shaft that drives the ribbon take-up roller drive shaft 11 and the tape-feeding-roller drive shaft 12, a cartridge shaft drive circuit 24 that controls the driving of the motor 23 to drive cartridge shaft, a print-head drive circuit 25 that controls electricity to the print head 10, a solenoid 26 that drives the cutter 15 for a cutting operation, a solenoid drive circuit 27 that controls the solenoid 26, a tape-feeding-roller motor 28 that drives the feeding roller 17, and a control circuit 30 that controls the entire operation of the apparatus 2 for communicating with a RFID label via the radio frequency circuit 21, the signal processing circuit 22, the cartridge shaft drive circuit 24, the print head drive circuit 25, the solenoid drive circuit 27, the tape-feeding-roller drive circuit 29 and the like.

The control circuit 30 is a so-called microcomputer. Though not shown in detail, the control circuit 30 includes a CPU, which is a central processing device, ROM, RAM and the like, and performs signal processing according to a program stored in the ROM in advance using the temporary storage function provided by the RAM. Also, the control circuit 30 is connected to the communication line, for example, via an input/output interface 31 and is capable of information exchange with the above-mentioned route server 4, other terminals 5, the general-purpose computer 6, the information server 7 and the like connected to the communication line.

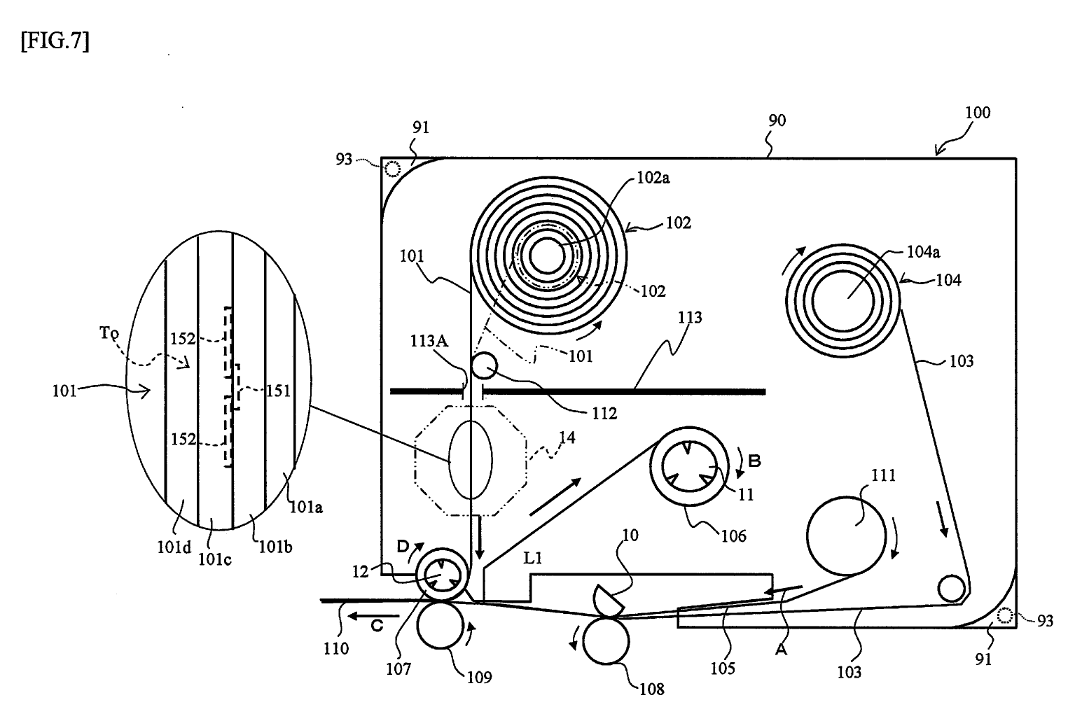

FIG. 7 is an explanatory diagram for illustrating a detailed structure of the cartridge 100.

In FIG. 7, the cartridge 100 includes the casing 90, the first roll 102 disposed within the casing 90 and around which the band-state base tape 101 is wound, the second roll 104 around which the transparent print-receiving tape 103 with the substantially same width as that of the base tape 101 is wound, a ribbon-supply-side roll 111 that feeds the ink ribbon 105 (thermal transfer ribbon, however, it is not needed when the print-receiving tape is a thermal tape), the ribbon take-up roller 106 that takes up the ribbon 105 after printing, a tape feeding roller 107, a guide roller 112, and a shield member 113 that passes the base tape 101 into its through hole 113A and reduces leakage of an electric wave signal from the antenna 14 to the side of the first roll 102.

The tape feeding roller 107 presses and bonds the base tape 101 and the print-receiving tape 103 together to have the tag label tape 110 with print and feeds the tape in a direction shown by an arrow A (also functioning as a tape feeding roller).

The first roll 102 has the base tape 101 in which a plurality of RFID circuit elements To is sequentially formed with a predetermined equal interval in the longitudinal direction wound around the reel member 102a.

The base tape 101 is in a four-layered structure in this example (See partially enlarged view in FIG. 7) and is constructed in lamination in the order of an adhesive layer 101a made of an appropriate adhesive, a colored base film 101b made of polyethylene terephthalate (PET) and the like, an adhesive layer 101c made of an appropriate adhesive, and a separation sheet (separation material) 101d from the side wound inside (right side in FIG. 7) toward the opposite side (left side in FIG. 7).

On the back side of the base film 101b (left side in FIG. 7), an antenna (tag antenna) 152 for transmission/reception of information is provided integrally in this example, an IC circuit part 151 connected to it and storing information is formed, and the RFID circuit element To is comprised by them.

On the front side of the base film 101b (right side in FIG. 7), the adhesive layer 101a that bonds the print-receiving tape 103 later is formed, while on the back side of the base film 101b (left side in FIG. 7), the separation sheet 101d is bonded to the base film 101b by the adhesive layer 101c provided so as to include the RFID circuit element To. The separation sheet 101d is used when the RFID label T finally completed in the label state is affixed to a predetermined article or the like, and it is affixed to the article or the like by the adhesive layer 101c by peeling off the separation sheet.

The second roll 104 has the print-receiving tape 103 wound around a reel member 104a. In the print-receiving tape 103 fed out of the second roll 104, the ribbon 105 arranged on its back face side (that is, the side to be bonded to the base tape 101) and driven by the ribbon-supply-side roll 111 and the ribbon take-up roller 106 is brought into contact with the back face of the print-receiving tape 103 by being pressed by the print head 10.

The ribbon take-up roller 106 and the tape feeding roller 107 are rotated and driven, respectively, by a driving force of the motor 23 to drive cartridge shaft (See the above-mentioned FIG. 6), which is a pulse motor, for example, provided outside the cartridge 100, transmitted to the ribbon take-up roller drive shaft 11 and the feeding roller drive shaft 12.

In the cartridge 100 of the above configuration, the base tape 101 fed out of the first roll 102 is supplied to the tape feeding roller 107. On the other hand, as for the print-receiving tape 103 fed out of the second roll 104, the ink ribbon 105 arranged on its back face side (that is, the side bonded to the base tape 101) and driven by the ribbon-supply-side roll 111 and the ribbon take-up roller 106 is pressed by the print head 10 and brought into contact with the back face of the print-receiving tape 103.

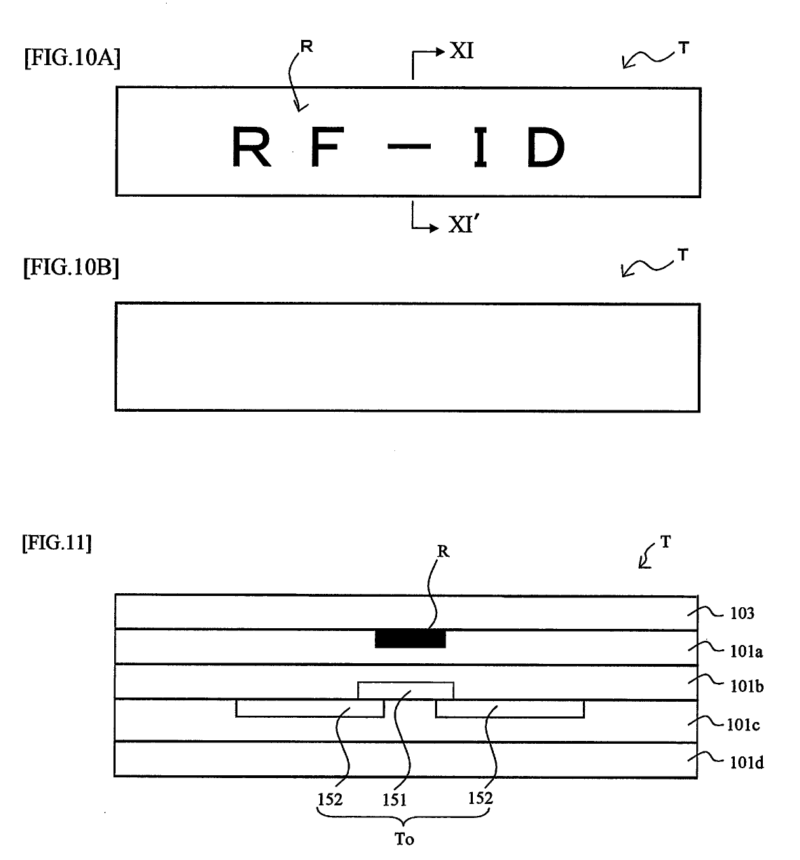

When the cartridge 100 is mounted to the cartridge holder portion CH of the main body 8 and a roll holder (not shown) is moved from the release position to the contact position, the print-receiving tape 103 and the ink ribbon 105 are held between the print head 10 and a platen roller 108, and the base tape 101 and the print-receiving tape 103 are held between the tape feeding roller 107 and a sub roller 109. Then, the ribbon take-up roller 106 and the tape feeding roller 107 are rotated and driven by the driving force of the motor 23 to drive cartridge shaft in a direction shown by an arrow B and an arrow D, respectively, in synchronization with each other. At this time, the feeding roller drive shaft 12, the sub roller 109 and the platen roller 108 are connected through the gear (not shown), and with the driving of the feeding roller drive shaft 12, the tape feeding roller 107, the sub roller 109, and the platen roller 108 are rotated, and the base tape 101 is fed out of the first roll 102 and supplied to the tape feeding roller 107 as mentioned above. On the other hand, the print-receiving tape 103 is fed out of the second roll 104, and the plurality of heater elements of the print head 10 is electrified by the print-head drive circuit 25. As a result, print R (See FIG. 10, which will be described later) corresponding to the RFID circuit element To on the base tape 101 to be bonded is printed on the back face of the print-receiving tape 103. Then, the base tape 101 and the print-receiving tape 103 on which the printing has been finished are bonded together by the tape feeding roller 107 and the sub roller 109 to be integrated and formed as the tag label tape 110 with print and fed out of the cartridge 100. The ink ribbon 105 finished with printing on the print-receiving tape 103 is wound up by the ribbon take-up roller 106 by driving of the ribbon take-up roller drive shaft 11.

A guide roller 112 guides the base tape 101 fed out of the first roll 102 so that the feeding path passes a predetermined position of the antenna 14 in the plane direction (substantially at the center position in this example) (or to be regulated in a predetermined range therefrom) even if the feeding-out position of the base tape 101 from the first roll 102 is fluctuated due to consumption of the base tape 101 (See a two-dot chain line in FIG. 7).

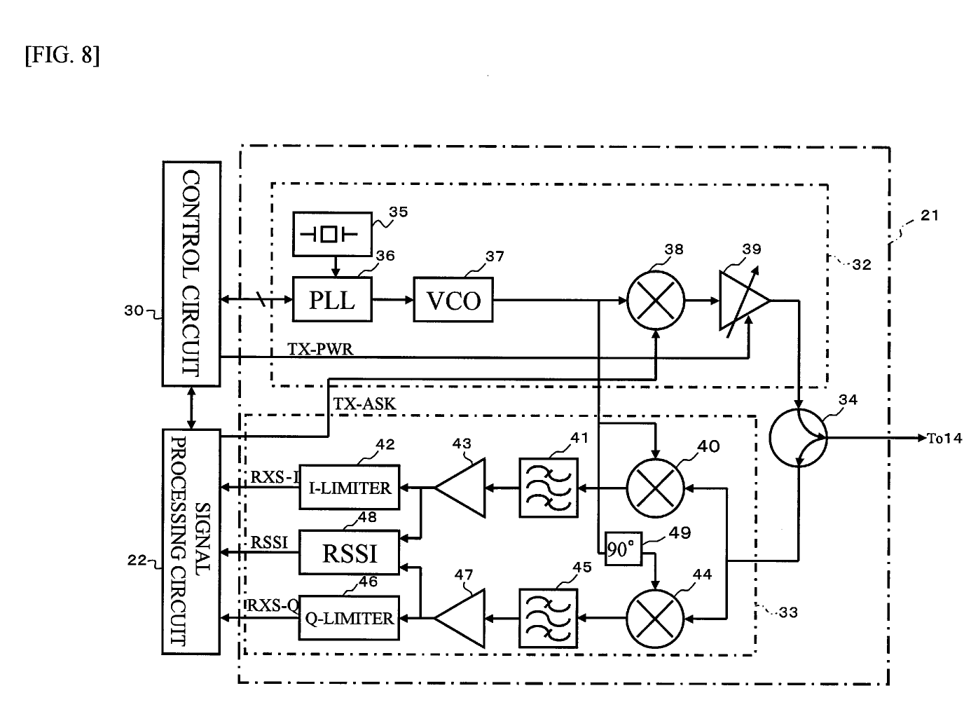

FIG. 8 is a functional block diagram illustrating detailed functions of the radio frequency circuit 21. In FIG. 8, the radio frequency circuit 21 includes a transmitting portion 32 that transmits a signal to the RFID circuit element To through the antenna 14, a receiving portion 33 for input of the reflected waves from the RFID circuit element To received by the antenna 14, and a transmit/receive splitter 34.

The transmitting portion 32 includes a crystal oscillator 35 that generates a carrier wave for accessing (reading or writing) the RFID tag information stored in the IC circuit part 151 of the RFID circuit element To, a PLL (Phase Locked Loop) 36, a VCO (Voltage Controlled Oscillator) 37, a transmission multiplying circuit 38 (however, it may be replaced by an amplitude factor variable amplifier or the like in the case of amplitude modulation) for modulating (in this example, amplitude modulation according to the “TX_ASK” signal supplied from the signal processing circuit 22) the carrier wave generated as described above based on a signal supplied from the signal processing circuit 22, and a variable transmission amplifier 39 that amplifies the modulated waves modulated by the transmission multiplying circuit 38 with an amplification factor determined according to a “TX_PWR” signal supplied from the control circuit 30. The UHF frequency band is preferably used for the carrier wave generated as described above and the output from the transmission amplifier 39 is transmitted to the antenna 14 through the transmit/receive splitter 34 and is supplied to the IC circuit part 151 of the RFID circuit element To.

The receiving portion 33 includes a I-phase receiving signal multiplying circuit 40 that multiplies the reflected wave received from the RFID circuit element To through the antenna 14 by the carrier wave generated as described above, a I-phase bandpass filter 41 that extracts only the signals within the necessary frequency band range from the output from the I-phase receiving signal multiplying circuit 40, a I-phase receiving signal amplifier 43 that amplifies the output from the I-phase bandpass filter 41 and supplies it to a I-phase limiter 42, a Q-phase receiving signal multiplying circuit 44 that multiplies the reflected wave received from the RFID circuit element To through the antenna 14 by the carrier wave that have been delayed by a phase shifter 49 by 90° after having been generated as described above, a Q-phase bandpass filter 45 that extracts only the signals within the necessary frequency band range from the output of the Q-phase receiving signal multiplying circuit 44, and a Q-phase receiving signal amplifier 47 that inputs and amplifies the output of the Q-phase bandpass filter 45 and supplies it to a Q-phase limiter 46. The signal “RXS-I” output from the I-phase limiter 42 and the signal “RXS-Q” output from the Q-phase limiter 46 are input to the signal processing circuit 22 for processing.

Furthermore, the outputs from the I-phase receiving signal amplifier 43 and the Q-phase receiving signal amplifier 47 are also input to an RSSI (Received Signal Strength Indicator) circuit 48, and the signal “RSSI” indicating the intensity of these signals is input to the signal processing circuit 22. As mentioned above, in the apparatus 2 for communicating with a RFID tag of this embodiment, the reflected wave from the RFID circuit element To is demodulated by the I-Q quadrature demodulation.

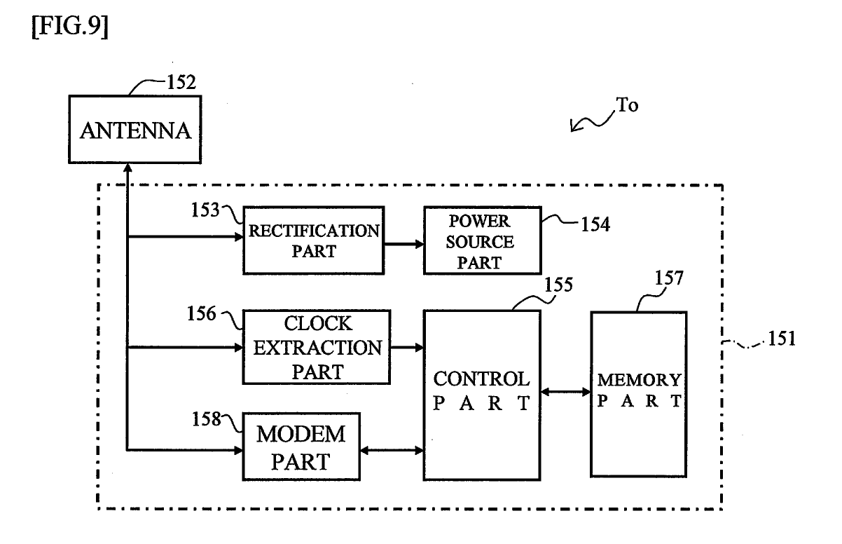

FIG. 9 is a functional block diagram illustrating functional configuration of the RFID circuit element To. In Fig. t, the RFID circuit element To has the antenna 152 for transmission/reception of a signal contactlessly with the antenna 14 on the side of the apparatus 2 for communicating with a RFID tag using a radio frequency such as an UHF band or the like and the IC circuit part 151 connected to the antenna 152.

The IC circuit part 151 includes a rectification part 153 that rectifies a carrier wave received by the antenna 152, a power source part 154 that accumulates energy of the carrier wave rectified by the rectification part 153 to make it a driving power source, a clock extraction part 156 that extracts a clock signal from the carrier wave received by the antenna 152 and supplies it to a control part 155, a memory part 157 that can store a predetermined information signal, a modem part 158 connected to the antenna portion 152, and the control part 155 that controls operations of the RFID circuit element To through the rectification part 153, the clock extraction part 156, the modem part 158 and the like.

The modem part 158 demodulates a communication signal from the antenna 14 of the apparatus 2 for communicating with a RFID tag received by the antenna 152 and modulates and reflects the carrier wave received by the antenna 152 based on a reply signal from the control part 155.

The control part 155 executes basic control such as control of interpreting the receiving signal demodulated by the modem part 158, generating a reply signal based on the information signal stored in the memory part 157, replying by the modem part 158 and the like.

The clock extraction part 156 extracts a clock component from the received signal into the control part 155 and supplies the clock corresponding to a speed of the clock component of the received signal to the control part 155.

FIGS. 10A and 10B are views illustrating an example of an appearance of a RFID label T formed by completing information writing in the RFID circuit element To and cutting of the tag label tape 110 with print as above, in which FIG. 10A is a top view and FIG. 10B is a bottom view. FIG. 11 is a cross sectional view by a XI-XI′ section in FIG. 10A.

In FIGS. 10A, 10B, and 11, the RFID label T is in the five-layered structure in which the print-receiving tape 103 is added to the four-layered structure shown in FIG. 7 made of the print-receiving tape 103, the adhesive layer 101a, the base film 101b, the adhesive layer 101c, and the separation sheet 101d from the side of the print-receiving tape 103 (upper side in FIG. 11) to the opposite side (lower side in FIG. 11). Then, the RFID circuit element To including the antenna 152 provided on the back side of the base film 101b as mentioned above is provided in the adhesive layer 101c, and a print R (characters of “RF-ID” indicating the type of the RFID label Tin this example) is printed on the back face of the print-receiving tape 103.

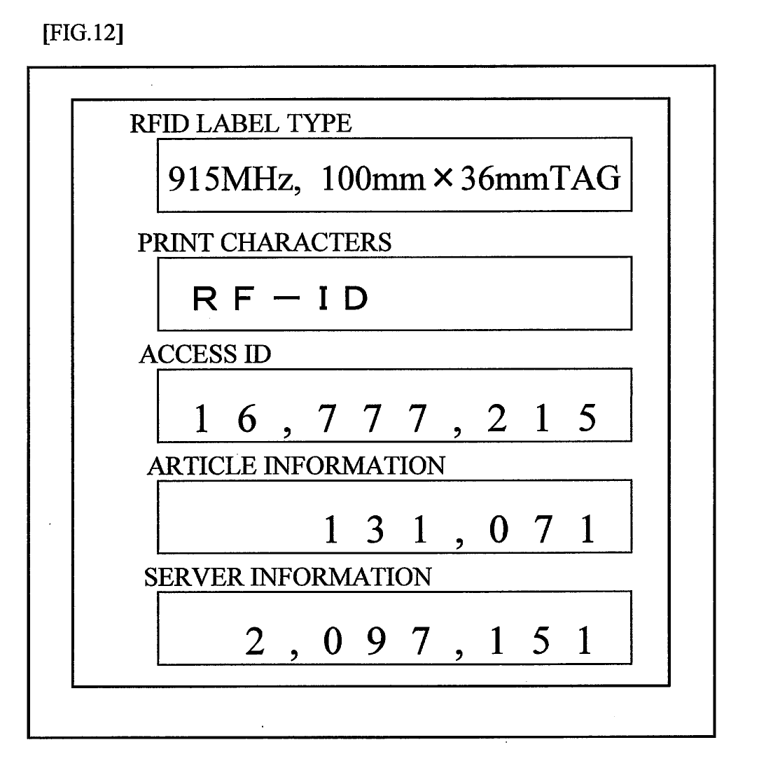

FIG. 12 is a view illustrating an example of a screen displayed on the above-mentioned terminal 5 or the general-purpose computer 6 at an access (reading or writing) to the RFID tag information of the IC circuit part 151 in the RFID circuit element To by the apparatus 2 for communicating with a RFID tag as mentioned above.

In FIG. 12, in this example, the type of the RFID label T (access frequency and tape dimension), the print characters R printed corresponding to the RFID circuit element To, an access (writing or reading) ID, which is identification information specific to the RFID circuit element To, an address of article information stored in the information server 7, storage destination address of the corresponding information in the route server 4 and the like can be displayed on the terminal 5 or the general-purpose computer 6. The apparatus 2 for communicating with a RFID tag is operated by operation of the terminal 5 or the general-purpose computer 6 so as to print the print characters R on the print-receiving tape 103, and the information such as the writing ID, article information and the like is written in the IC circuit part 151 (or the RFID tag information such as the article information stored in advance in the IC circuit part 151 is read out). The “reading/writing” of the RFID tag information in this case includes not only commonly used data reading/writing but also transmission of signals to stop a response such as a signal based on “Kill” and “Sleep” commands.

At the above writing (or reading), correspondence between the ID of the produced RFID label T and the information read out from the IC circuit part 151 of the RFID label T (or the information written in the IC circuit part 151) is stored in the above-mentioned route server 4 so as to be referred to as necessary.

The most distinctive characteristic of the present embodiment is in the cartridge 100, which is a container for including RFID tag, the rib contact face 91a is provided on the side of the cartridge 100 and the positioning pin 93 that supports the rib contact face 91a in contact on the side of the apparatus 2 for communicating with a RFID tag so that a distance between the antenna 152 of the RFID circuit element To and the antenna 14 on the side of the apparatus 2 for communicating with a RFID tag (distance in the tape-width direction, in other words, distance of the cartridge holder CH in the depth direction) is kept substantially constant. This will be described below in detail referring to a comparative example.

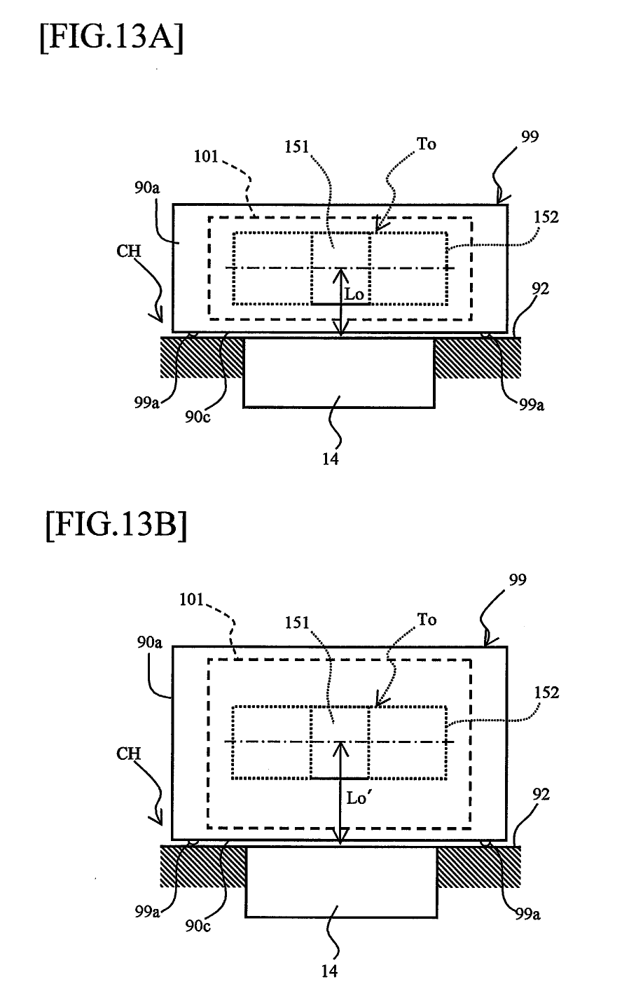

FIGS. 13A and 13B are conceptual diagrams illustrating a state where a cartridge 99 not provided with a positioning rib as a comparative example of the present invention is placed on the cartridge holder portion CH on which a positioning pin is not provided, in which FIG. 13A is a diagram illustrating a placed state of the cartridge 99 provided with a base tape 101 with a narrow tape width, while FIG. 13B is a diagram illustrating a placed state of the cartridge 99 provided with the base tape 101 with a wide tape width. The portions equivalent to the above-mentioned present embodiment are given the same reference numerals.

In FIGS. 13A and 13B, in the cartridge 99, the thickness of a casing main body 90a is different according to the tape width of the base tape 101 provided inside, and as compared with the case of the cartridge 99 where the tape width of the base tape 101 is narrow as shown in FIG. 13A (24 mm, for example), the cartridge 99 with the wide tape width of the base tape 101 as shown in FIG. 13B (36 mm, for example) is formed with a larger thickness dimension of the casing main body 90a.

Usually, the RFID circuit element To is arranged at a predetermined position of the base tape 101 in the tape-width direction (center in the width direction in this example), and distances Lo, Lo′ from the center position of the tag antenna 152 to the casing bottom face 90c are different between the case where the tape width of the base tape 101 (FIG. 13A) is narrow and the case where that is wide (FIG. 13B).

Therefore, when the states where the respective cartridges 99 are placed by a round boss 99a (or the respective cartridge 99 is placed on a short support shaft provided on the holder bottom face 92) on the holder bottom face 92 in which the device antenna 14 is embedded are compared, a communication distance between the tag antenna 152 and the device antenna 14 in each case is different from each other, and if the both cartridges 99 are replaced and mounted to the same cartridge holder portion CH, radio communication would become unstable.

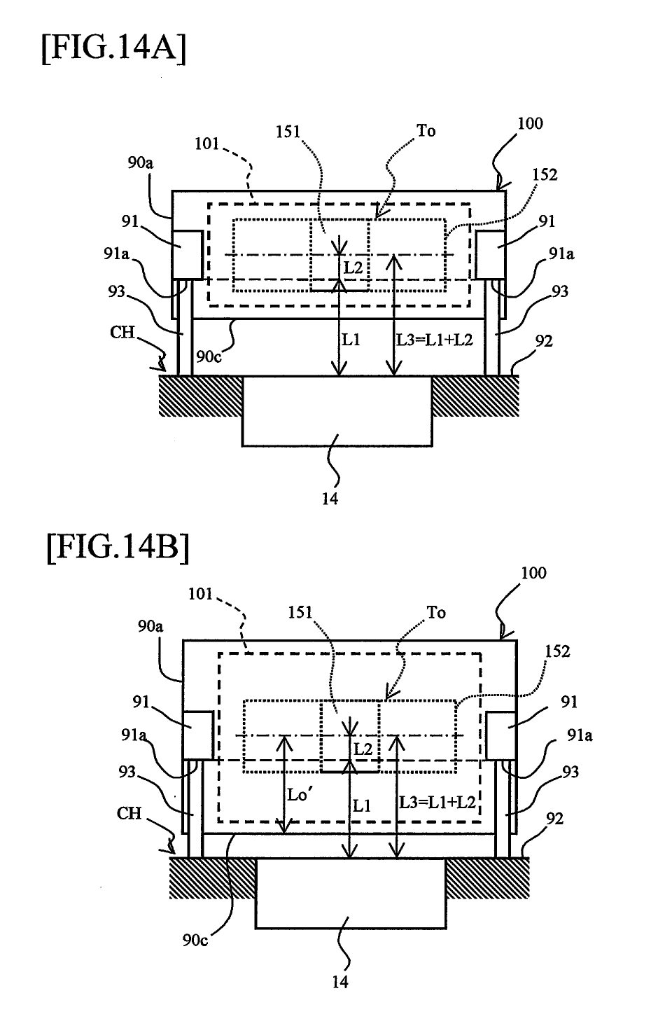

FIGS. 14A and 14B are a conceptual diagram illustrating a support state of the positioning rib 91 by the positioning pin 93 when the cartridge 100 is attached to the cartridge holder portion CH in the cartridge 100 and the apparatus 2 for communicating with a RFID tag, in which FIG. 14A is a diagram illustrating a support state of the cartridge 100 provided with the base tape 101 with a narrow tape width, while FIG. 14B is a diagram illustrating a support state of the cartridge 100 provided with the base tape 101 with a wide tape width. FIGS. 14A and 14B correspond to arrow views schematically showing the support state of the cartridge when seen from the P direction in FIG. 6.

In FIGS. 14A and 14B, in each cartridge 100, the casing main body 90a of the cartridge 100 provided with the base tape 100 with a wide tape width is also formed with a thickness dimension larger than that of the casing main body 90a of the cartridge 100 provided with the base tape 101 with a narrow tape width, and the distances Lo, Lo′ between the center position of the tag antenna 152 and the casing bottom face 90c are different from each other.

As mentioned above, in the cartridge 100 according to the present embodiment, the positioning ribs 91 are provided at two corner portions on the diagonal line (shown at right and left two locations in the figure), and the rib contact faces 91a are formed as substantially flat planes facing substantially in parallel with the holder bottom face 92. Also, all the rib contact faces 91a of the both cartridges 100 are commonly arranged by being separated from the center position of the tag antenna 152, respectively, by the same distance (second fixed value) L2.

In the state where the respective cartridges 100 are mounted, the positioning pins 93 projecting from the holder bottom face 92 at the same height (third fixed value) L1 support the cartridges 100 in contact with the rib contact faces 91a at their distal ends.

By this arrangement, the two cartridges 100 are supported by the positioning pins 93 so that the distance L3 as a sum of the distance L2 from the center position of the tag antenna 152 to the rib contact face 91a and the height L1 of the positioning pin 93 is kept constant (constant as a first fixed value as the sum of the second fixed value and the third fixed value). That is, even if the both cartridges 100 are replaced and mounted to the same cartridge holder portion CH, the communication distance between the tag antenna 152 and the device antenna 14 can be kept constant all the time in each case. At this time, in each case where the respective cartridges 100 are attached, the positioning pin 93 holds the respective cartridges 100 horizontally when seen in FIGS. 14A and 14B (the distance from the respective cartridges to the side of the holder bottom face 92 in the apparatus 2 for communicating with a RFID tag is kept constant at least above the antenna 14).

A control procedure executed by the control circuit 30 will be described below.

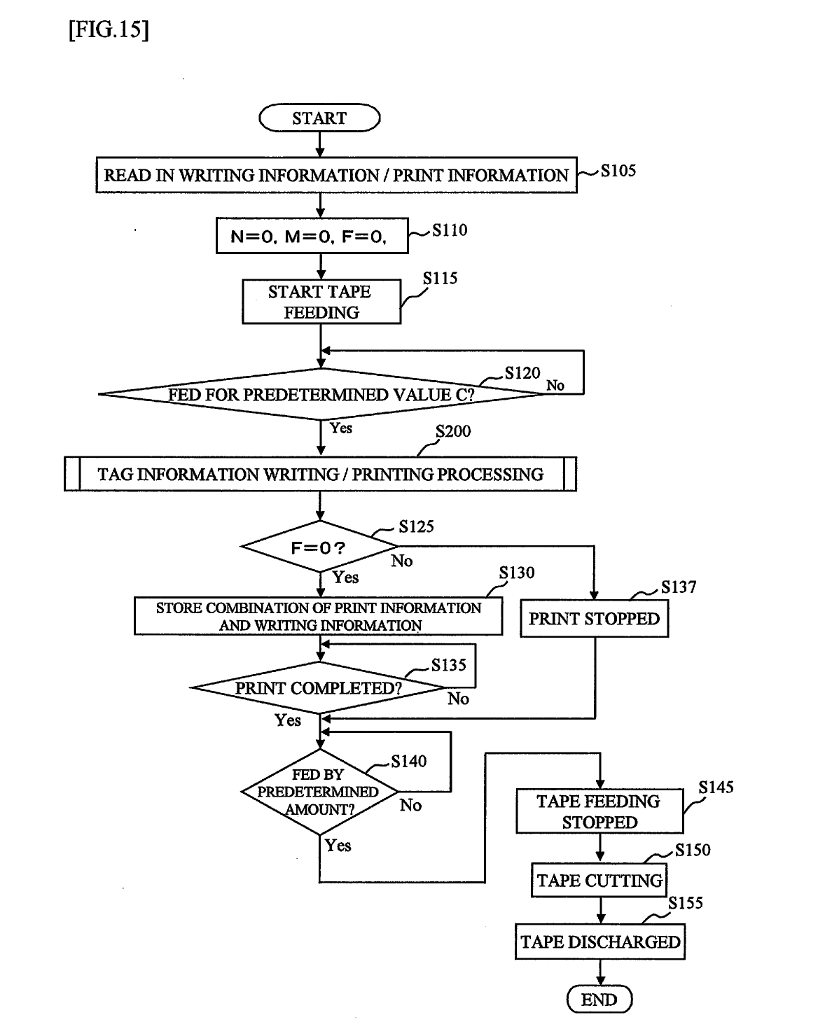

FIG. 15 is a flowchart illustrating the control procedure executed by the control circuit 30 for the above-mentioned production of the RFID label T, that is, the print-receiving tape 103 is fed and a predetermined print is applied by the print head 10, while the base tape 101 is fed and the RFID tag information is written, the print-receiving tape 103 and the base tape 101 are bonded together to have the tag label tape 110 with print, and then, the tag label tape 110 with print is cut for each RFID circuit element To produce the RFID label T.

In FIG. 15, first, at Step S105, when the writing operation by the apparatus 2 for communicating with a RFID tag is carried out, this flow is started. Then, the RFID tag information input and operated via the terminal 5 or the general-purpose computer 6 and to be written in the RFID circuit element To and print information to be printed by the print head 10 onto the RFID label T in correspondence with the RFID tag information are read in via the communication line 3 and the input/output interface 31.

Thereafter, at Step S110, there is no response from the RFID circuit element To, and variables M, N for counting the number of retry times (number of access trial times) and a flag F indicating communication state are initialized to zero.

Then, at Step S115, a control signal is output to the cartridge shaft drive circuit 24, and the ribbon take-up roller 106 and the tape feeding roller 107 are rotated and driven by a driving force of the motor 23 to drive cartridge shaft. By this arrangement, the base tape 101 is fed out of the first roll 102 and supplied to the tape feeding roller 107, while the print-receiving tape 103 is fed out of the second roll 104. Moreover, a control signal is output to the tape-feeding-roller motor 28 through the tape-feeding-roller drive circuit 29 so as to rotate and drive the feeding roller 17. As a result, the base tape 101 and the print-receiving tape 103 are bonded and integrated by the tape feeding roller 107 (and the sub roller 109) as mentioned above so as to be formed as the tag label tape 110 with print and fed outside the cartridge 100.

Thereafter, the routine goes to Step S120, where it is determined if the base tape 101 and the print-receiving tape 103 have been fed for a predetermined value C (a feeding distance for which the RFID tag information writing and printing to the preceding RFID circuit element To and the corresponding print-receiving tape 103 print region have been finished and the subsequent RFID circuit element To reaches a position substantially facing the antenna 14, for example). This feeding distance determination at this time can be made, for example, by detecting an appropriate identification mark provided on the base tape 101 by a known tape sensor provided separately. If the determination is satisfied, the program goes on to the subsequent Step S200.

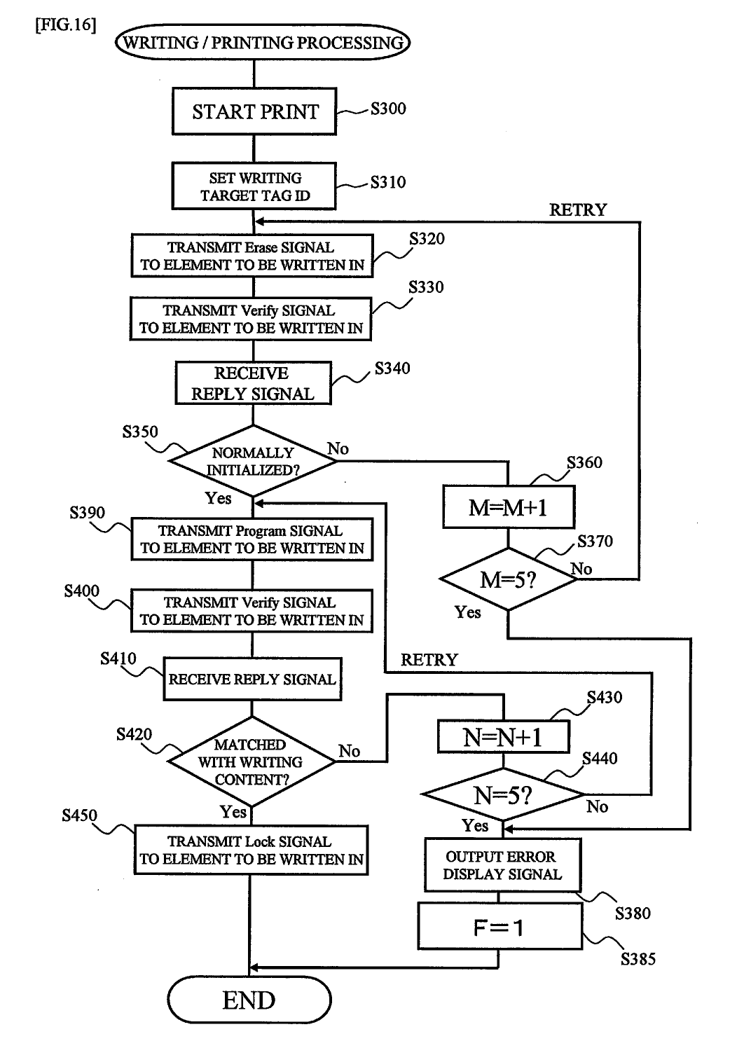

At Step S200, the tag information writing/printing processing is performed, and after memory initialization (deletion) for writing, a transmission signal including the RFID tag information is transmitted to and written in the RFID circuit element To on the base tape 101 and the print R is printed by the print head 10 on the corresponding region on the print-receiving tape 103 (for detail, see FIG. 16, which will be described later). When Step S200 is finished, the program goes to Step S125.

At Step S125, it is determined if the flag F=0 or not. If the writing processing has been normally completed, it is still F=0 (See Step S385 in the flow shown in FIG. 16, which will be described later), and therefore the determination is satisfied and the program goes to Step S130.

At Step S130, combination of the information written in the RFID circuit element To at Step S200 and the print information having been printed by the print head 10 correspondingly is output through the terminal 5 or the general-purpose computer 6 via the input/output interface 31 and the communication line 3 and stored in the information server 7 and the route server 4. Incidentally, the stored data is stored and held in the database, for example, so as to be referred to by the terminal 5 or the general-purpose computer 6 as needed.

Thereafter, at Step S135, it is confirmed whether all the prints in the region corresponding to the RFID circuit element To be processed at this time in the print-receiving tape 103 have been completed or not, and then, the program goes to Step S140.

At the above-mentioned Step S125, if the writing processing has not been normally completed for some reason, it becomes F=1 (See Step S385 in the flow shown in FIG. 16, which will be described later), and the determination at Step S125 is not satisfied and the program goes on to Step S137, where a control signal is output to the print-head drive circuit 25 so as to stop electricity to the printhead 10 and stop printing. It is clearly displayed that the RFID circuit element To is not a non-defective product by interruption of printing in this way. Instead of the interruption of printing, a print in a special mode such as an alarm, notification or the like of the gist may be made.

After this Step S137 is finished, the routine goes to Step S140.

At Step S140, it is determined if the tag label tape 110 with print has been further fed by a predetermined amount (a feeding distance that the RFID circuit element To be a target and the whole print region of the print-receiving tape 103 corresponding to that exceeds the cutter 15 by a predetermined distance (margin amount), for example). The determination on the feeding distance at this time can be also made only by detecting marking, for example, by a tape sensor similarly to the above-mentioned Step S120. If the determination is satisfied, the program goes to Step S145.

At Step S145, a control signal is output to the cartridge shaft drive circuit 24 and the tape-feeding-roller drive circuit 29 so as to stop driving of the motor 23 to drive cartridge shaft and the tape-feeding-roller motor 28 and to stop rotation of the ribbon take-up roller 106, the tape feeding roller 107, and the feeding roller 17. By this arrangement, feeding-out of the base tape 101 from the first roll 102, feeding-out of the print-receiving tape 103 from the second roll 104, and feeding of the tag label tape 110 with print by the feeding roller 17 are stopped.

Thereafter, at Step S150, a control signal is output to the solenoid drive circuit 27 so as to drive the solenoid 26, and the tag label tape 110 with print is cut by the cutter 15. As mentioned above, the whole of the tag label tape 110 with print onto which the RFID circuit element To be processed and the print region of the print-receiving tape 103 corresponding thereto are bonded have sufficiently exceeded the cutter 15 at this time, and by the cutting by this cutter 15, the RFID tag information is written in the RFID circuit element To and the label-state RFID label T with the predetermined print corresponding thereto is produced.

Thereafter, the program goes to Step S155, where a control signal is output to the tape-feeding-roller drive circuit 29, driving of the tape-feeding-roller motor 28 is resumed and the feeding roller 17 is rotated. By this arrangement, the feeding by the feeding roller 17 is resumed, and the RFID label T produced in the label state at Step S150 is fed toward the carry-out exit 16 and discharged from the carry-out exit 16 to outside of the apparatus 2.

FIG. 16 is a flowchart illustrating a detailed procedure of the above-mentioned Step S200.

In FIG. 16, first, at Step S300, a control signal is output to the print-head drive circuit 25 so as to electrify the print head 10 and to print the print R such as characters, symbols, barcodes and the like read in at Step S105 in the above-mentioned FIG. 15 on a region corresponding to the RFID circuit element To be processed in the print-receiving tape 103 (region to be bonded by the tape feeding roller 107 to the back face of the RFID circuit element To).

Then, at Step S310, an identification number ID to be allocated to the RFID circuit element To be written in is set by a known appropriate method.

Thereafter, at Step S320, an “Erase” command to initialize information stored in the memory part 157 of the RFID circuit element To is output to the signal processing circuit 22. Based on this, an “Erase” signal as access information is generated at the signal processing circuit 22 and transmitted to the RFID circuit element To be written in through the radio frequency circuit 21 so as to initialize the memory part 157.

Next, at Step S330, a “Verify” command to verify contents of the memory part 157 is output to the signal processing circuit 22. Based on this, a “Verify” signal as the access information is generated at the signal processing circuit 22 and transmitted to the RFID circuit element To into which the information is to be written through the radio frequency circuit 21, and a reply is prompted. Thereafter, at Step S340, a reply signal sent in response to the “Verify” signal from the RFID circuit element To be written in is received through the antenna 14 and taken in through the radio frequency circuit 21 and the signal processing circuit 22.

Next, at Step S350, based on the reply signal, information in the memory part 157 of the RFID circuit element To is confirmed so as to determine if the memory part 157 has been normally initialized or not.

If the determination is not satisfied, the program goes to Step S360 and one is added to M, and moreover, at Step S370, if it is M=5 or not is determined. In the case of M≦4, the determination is not satisfied but the program returns to Step S320 and the same procedure is repeated. In the case of M=5, the program goes to Step S380, where an error display signal is output to the terminal 5 or the general-purpose computer 6 via the input/output interface 31 and the communication line 3, corresponding writing failure (error) display is made, and this flow is finished. In this way, even if initialization is not successful, retry is made up to five times.

If the determination at Step S350 is satisfied, the program goes to Step S390, where a “Program” command to write desired data in the memory part 157 is output to the signal processing circuit 22. Based on this, a “Program” signal as the access information including the ID information to be written is generated at the signal processing circuit 22 and transmitted to the RFID circuit element To into which the information is to be written through the radio frequency circuit 21, and the information is written in the memory part 157.

Thereafter, at Step S400, the “Verify” command is output to the signal processing circuit 22. Based on this, the “Verify” signal as the access information is generated at the signal processing circuit 22 and transmitted to the RFID circuit element To into which the information is to be written through the radio frequency circuit 21, and a reply is prompted. Thereafter, at Step S410, a reply signal sent in response to the “Verify” signal from the RFID circuit element To be written in is received through the antenna 14 and taken in through the radio frequency circuit 21 and the signal processing circuit 22.

Next, at Step S420, based on the reply signal, information stored in the memory part 157 of the RFID circuit element To is confirmed, and it is determined if the predetermined information transmitted as above has been normally stored in the memory part 157 or not.

If the determination is not satisfied, the program goes to Step S430, where one is added to N and whether it is N=5 or not is determined at Step S440. In the case of N≦4, the determination is not satisfied but the program returns to Step S390 and the same procedure is repeated. In the case of N=5, the program goes to the above-mentioned Step S380, where corresponding writing failure (error) display is similarly made on the terminal 5 or the general-purpose computer 6, the above-mentioned flag is set at the flag F=1 at Step S385, and this flow is finished. In this way, even if information writing is not successful, retry is made up to five times.

If the determination at Step S420 is satisfied, the program goes to Step S450, where a “Lock” command is output to the signal processing circuit 22. Based on this, a “Lock” signal is generated at the signal processing circuit 22 and transmitted to the RFID circuit element To into which the information is to be written through the radio frequency circuit 21, and new information writing in the RFID circuit element To is prohibited. By this arrangement, writing of the RFID tag information in the RFID circuit element To be written is completed, the RFID circuit element To is discharged as above, and the flow is finished.

By the above routine, in the cartridge 100, the corresponding RFID tag information can be written to the RFID circuit element To be written on the base tape 101 and the print R corresponding to the RFID tag information can be printed on the corresponding region on the print-receiving tape 103.

In the cartridge 100 and the apparatus 2 for communicating with a RFID tag of the present invention configured as above, the cartridge 100 containing the base tape 101 provided with the RFID circuit element To is attached to the cartridge holder portion CH when the RFID label T is to be produced, and radio communication is performed from the device antenna to the RFID circuit element To of the base tape 101 continuously supplied from the cartridge 100.

At this time, the cartridge 100 of the present embodiment is provided with the rib contact face 91a to be a positioning reference at the above attachment as shown in FIG. 14, and the apparatus 2 for communicating with a RFID tag of the present invention is provided with the positioning pin 93 corresponding to the rib contact face 91a. By this arrangement, even if the various cartridges 100 with different tag attribute parameters such as the size (particularly the tape width) of the base tape 101 are appropriately replaced for use, the distance between the tag antenna 152 and the device antenna 14 is kept substantially constant regardless of the type or size of the cartridge 100, and the communication distance can be kept substantially constant all the time. As a result, a stable communication range can be obtained and assured and stable communication can be performed.

Also, in the present embodiment, particularly the distance L2 from the rib contact face 91a to the center position of the tag antenna 152 is set as a fixed value (second fixed value), the distance L1 from the device antenna 14 to the distal end of the positioning pin 93 is set as a fixed value (third fixed value), and thereby a sum of the second fixed value and the third fixed value is also made as a fixed value (first fixed value). By this arrangement, the distance from the device antenna 14 to the tag antenna 152 can be made as a substantially constant value substantially equal to the first fixed value. Also, the distance L2 (second fixed value) from the rib contact face 91a to the center position of the tag antenna 152 may be set at zero, that is, the rib contact face 91a may be formed at a position in the same thickness direction as the center position of the tag antenna 152. In this case, the distance L1 from the device antenna 14 to the distal end of the positioning pin 93 becomes the first fixed value (distance L3) as it is, and the center position of the tag antenna 152 can be arranged at the same height as the distal end of the positioning pin 93 at attachment of the cartridge 100.

The first embodiment is capable of more various variations. The variations will be described below in order.

(1-1) When a plurality of types of combinations of the corresponding positioning reference portion and positioning support member is provided:

That is, in the first embodiment, only one type of combination of the positioning reference portion (rib contact face 91a) to be a positioning reference at cartridge attachment and the corresponding positioning support member (positioning pin 93) is provided, and the distance L1 from the positioning support member to the device antenna 14 and the distance L2 from the positioning reference portion to the center position of the tag antenna 152 are set as fixed values common to all the types of the cartridges 100. However, not limited to that, a plurality of combinations of the corresponding positioning reference portion and the positioning support member may be provided so that cooperative support may be given selectively from the plurality of combinations according to the type of the cartridge 100.

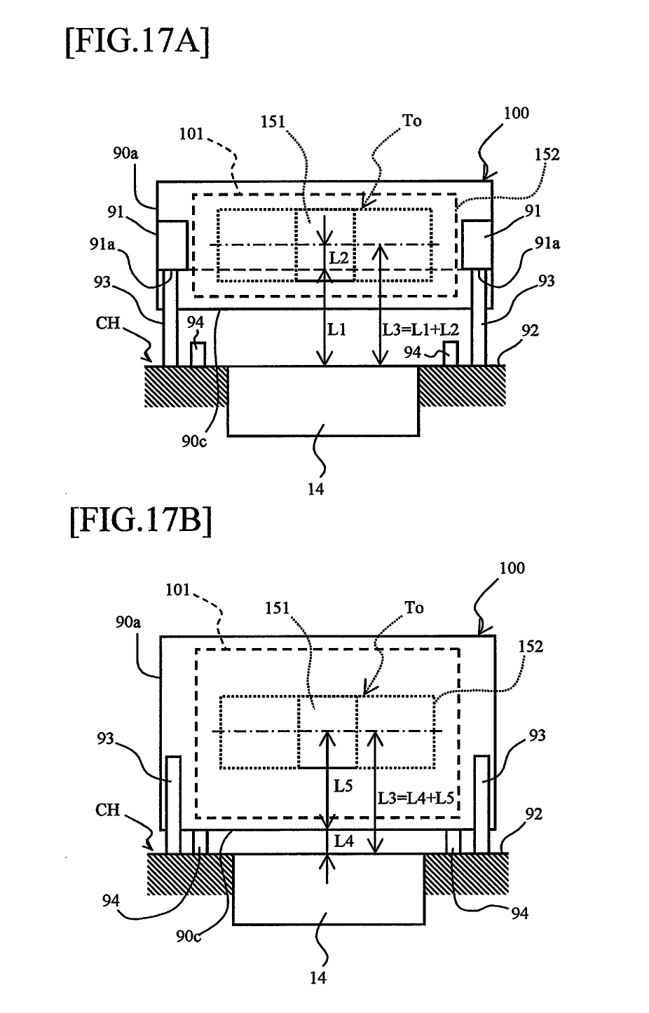

FIGS. 17A and 17B are views illustrating the support state of the positioning reference portion by the positioning support member when the cartridge 100 is attached to the cartridge holder portion CH in the cartridge 100 provided with two types of combinations of the corresponding positioning reference portion and the positioning support member and the apparatus 2 for communicating with a RFID tag and correspond to FIGS. 14A and 14B of the first embodiment. Incidentally, the same portions as in the first embodiment are given the same reference numerals and descriptions are omitted as appropriate.

In FIG. 17A, the positioning ribs 91 are provided at the corners of the cartridge 100 provided with the base tape 101 with a narrow tape width, while in FIG. 17B, the positioning rib is not provided at the cartridge 100 provided with the base tape with a wide tape width (though not particularly shown, a round is similarly formed when the cartridge 100 is seen from the upper face). In the cartridge 100 in FIG. 17B, the casing bottom face 90c is the positioning reference portion and the center position of the tag antenna 152 is separated from the casing bottom face 90c by a distance L5.

Also, on the holder bottom face 92 of the apparatus 2 for communicating with a RFID tag, support pins 94 with the height lower than the height L1 of the positioning pin 93 are projected at a plurality of positions under the casing bottom face 90c other than the positioning pins 93 with the height L1 (only two spots inside the two positioning pins 93 are shown in the figure), and the support pins 94 are positioning support members for the cartridge 100 in FIG. 17B.

In FIG. 17B, when the cartridge 100 is attached, the positioning pins 93 are not in contact with the cartridge 100 but separated from the round corner portions, and instead, the distal ends of the support pins 94 are brought into contact with the casing bottom face 90c of the cartridge 100 so as to support the cartridge 100.

Then, in the supported state of the cartridge 100 shown in FIG. 17B, the sum of the distance L5 from the center position of the tag antenna 152 to the casing bottom face 90c and the height L4 of the support pin is the same dimension as the distance L3 from the center position of the tag antenna 152 in the cartridge 100 supported state to the device antenna 14.

That is, in both the cartridge 100 supported states, though the combinations of the positioning support members for contact support and the positioning reference portions are different from each other, the distance from the center position of the tag antenna 152 to the device antenna 14 is the same distance L3 (L3=L1+L2=L4+L5) and can be made constant. That is, even if either of the cartridges 100 is replaced and attached to the same cartridge holder portion CH, the communication distance between the tag antenna 152 and the device antenna 14 can be made constant all the time in each case.

In this variation, too, the same effect as that in the first embodiment can be obtained. The number of combinations of the corresponding positioning reference portion and the positioning support member may be more than two as above and in that case, an insertion hole or the like should be formed on the side of the cartridge so that the positioning support member other than the combination for contact support is not brought into contact with the cartridge.

(1-2) When the RFID circuit element is for read only:

In the above, such a case is described that the RFID tag information is transmitted to the RFID circuit element To and written in the IC circuit part, but not limited to that. That is, there can be a case that the RFID tag information is read out from the read-only RFID circuit element To in which predetermined RFID tag information (tag identification information or the like) is unrewritably stored and held in advance, while the corresponding print is applied so as to produce a label, and the present invention can be applied to this case.

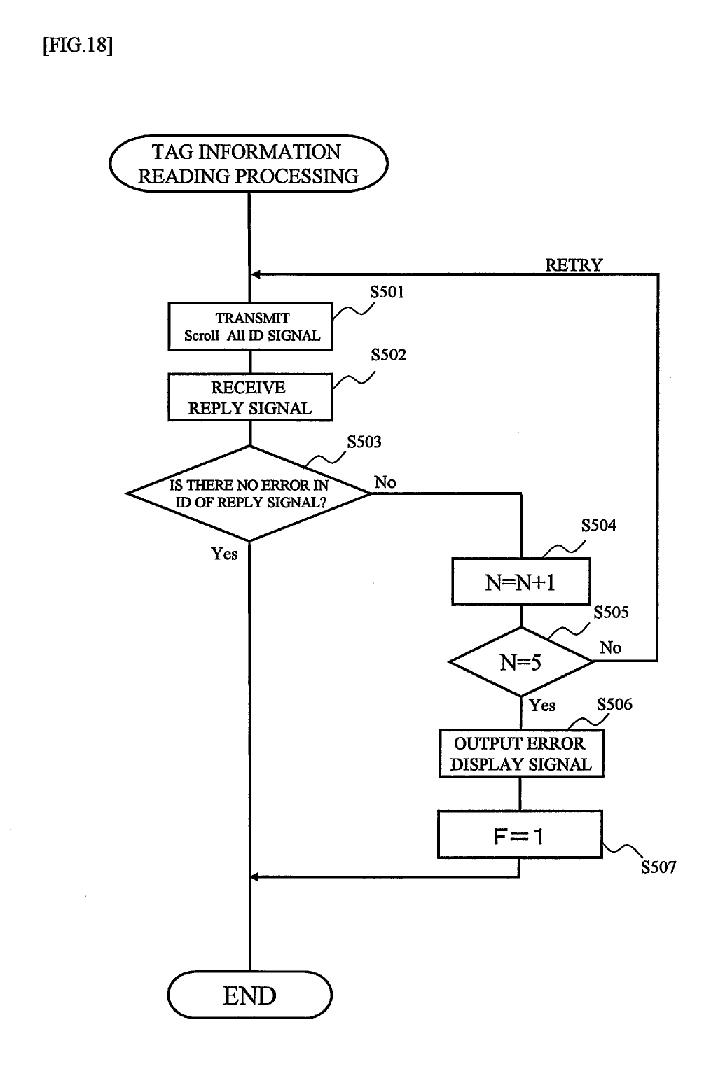

In this case, only print information is read in at Step S105 in FIG. 15, and reading processing of the RFID tag information may be performed at Step S200 (For details, see FIG. 18, which will be described later). After that, at Step S130, the combination of the print information and the read-out RFID tag information is stored.

FIG. 18 is a flowchart illustrating a detailed procedure of the RFID tag reading processing.

In FIG. 18, when the RFID circuit element To from which information is to be read out is fed to the vicinity of the antenna 14, at Step S501, a “Scroll All ID” command to read out the information stored in the RFID circuit element To is output to the signal processing circuit 22. Based on this, a “Scroll All ID” signal as RFID tag information is generated at the signal processing circuit 22, transmitted to the RFID circuit element To be read out through the radio frequency circuit 21 and a reply is prompted.

Next, at Step S502, the reply signal (RFID tag information including tag ID information and the like) transmitted from the RFID circuit element To be read out in response to the “Scroll All ID” signal is received through the antenna 14 and taken in via the radio frequency circuit 21 and the signal processing circuit 22.

Next, at Step S503, it is determined whether or not the reply signal received at Step S502 has no error using a known error detection code (CRC code; Cyclic Redundancy Check or the like).

If the determination is not satisfied, the routine goes to Step S504, where one is added to N and whether it is N=5 or not is determined at Step S505. In the case of N≦4, the determination is not satisfied but the program returns to Step S501 and the same procedure is repeated. In the case of N=5, the program goes to Step S506, where an error display signal is output to the terminal 5 or the general-purpose computer 6 via the input/output interface 31 and the communication line 3 and corresponding reading failure (error) display is made, and then, the flag is set at the flag F=1 at Step S507, and this routine is finished. In this way, even if information reading is not successful, retry is made up to five times so that reading reliability can be ensured.

If the determination is satisfied at Step S503, the reading of the RFID tag information from the RFID circuit element To be read out is completed, and this routine is finished.

In the above routine, in this variation, the RFID tag information (tag identification information or the like) in the IC circuit part of the RFID circuit element To be read out in the cartridge can be accessed and read out.

In this variation, too, the same effect as in the first embodiment can be obtained.

Next, a second embodiment of the present invention will be described below referring to the attached drawings. This embodiment is an example where the present invention is applied to another type of the apparatus for communicating with a RFID tag. In each figure, the portions equivalent to those in the first embodiment are given the same reference numerals and description will be omitted as appropriate.

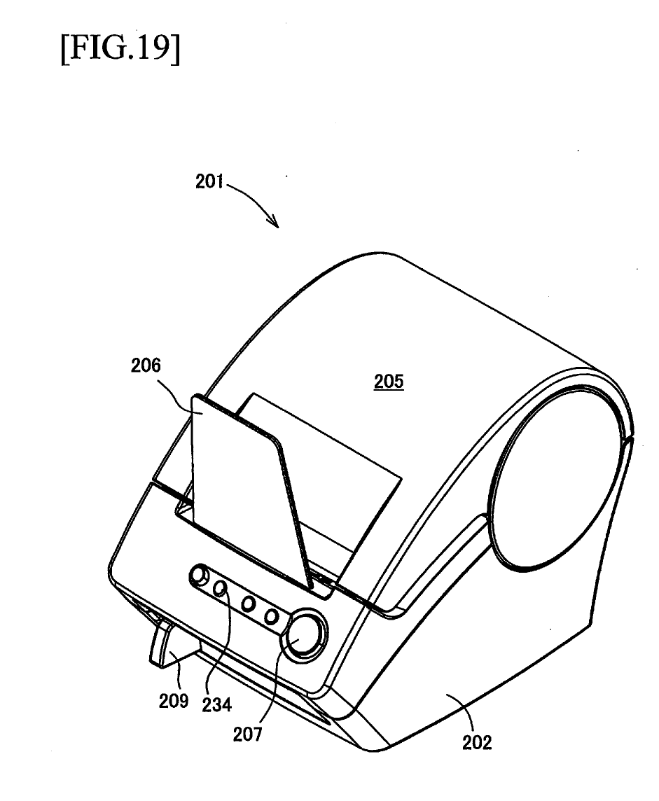

FIG. 19 is a perspective view illustrating schematic configuration of the apparatus for communicating with a RFID tag of this embodiment.

In FIG. 19, the apparatus 201 for communicating with a RFID tag comprises a main body housing 202, a transparent resin-made upper cover 205, a transparent resin-made tray 206 vertically provided substantially opposing the front center of the upper cover 205, a power-supply button 207 provided on the front of the tray 206, a cutter lever 209, an LED lamp 234 and the like.

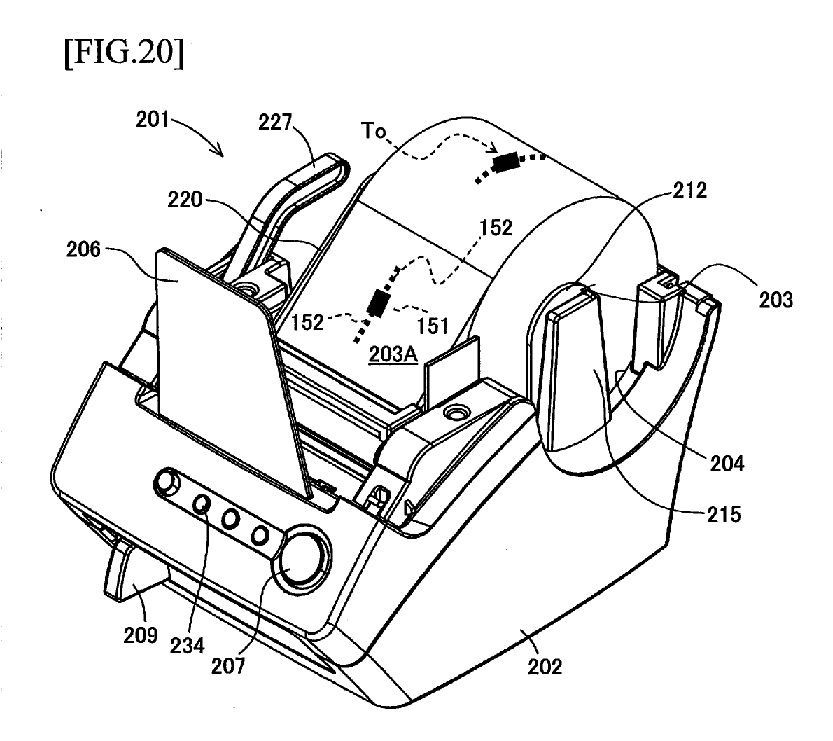

FIG. 20 is a perspective view illustrating the apparatus 201 for communicating with a RFID tag shown in FIG. 19 with the upper cover 205 removed.

In FIG. 20, a tape holder 203 is received in a tape holder containing portion (holder for installing a container, cartridge holder) 504. The tape holder 203 comprises a holder holding member 212 and a guide member 220, with the tag tape 203A (tag medium) having a predetermined width being rotatably wound around. In other words, the guide member 520 as a side wall on one side and the holder holding member 212 as a side wall on the other side are provided at both edges of the tag tape 203A in its axial direction, substantially orthogonally to the axial line. In addition, the above-mentioned upper cover 205 is attached allowing open and close movements thereof to the back side upper edge so as to cover the top of the tape holder containing portion 204.

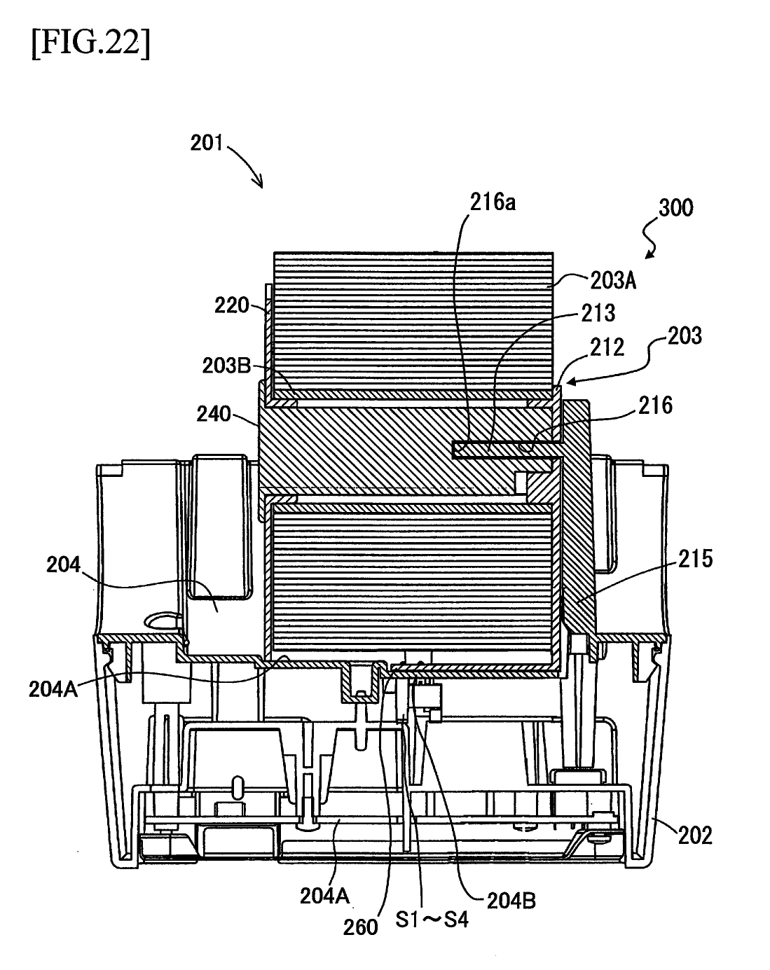

A holder support member 215 is provided at one of side end edge portions substantially in the perpendicular direction to the feeding direction of a tape holder containing portion 204, and at the holder support member 215, a holder positioning rod (positioning support member) 213 is installed upright on the side end face toward the tape holder containing portion 204 (See FIG. 22, which will be described later). As shown in the figure, when the tape holder 203 is contained and arranged in the tape holder containing portion 204, the holder positioning rod 213 is in a state inserted in a holder holding member 212.

At the front end portion in the feeding direction of the other side end edge portion of the tape holder containing portion 204, a lever 227 is provided. In the above tag tape 203A, the RFID circuit element To provided with the IC circuit part 151 and the antenna 152 is provided at the center part in the width direction in this embodiment.

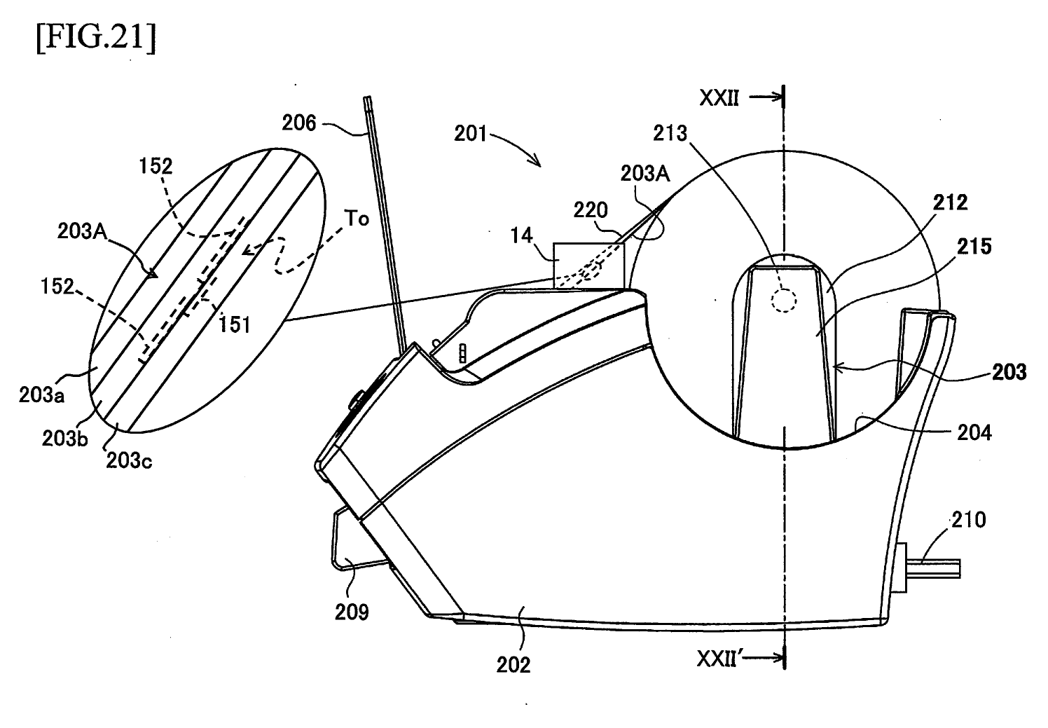

FIG. 21 is a side view of the structure shown in FIG. 20.

As shown in FIG. 21, the tag tape 203A having a three-layer structure (see partially enlarged view of FIG. 21) in this example, is formed by laminating, from the outward winding side (left top in FIG. 21) toward the opposite side (right bottom in FIG. 21), a separation sheet 203a, an adhesive layer 203b, and an elongated self-coloring thermal paper 203C, in this sequence.

On the back side (top left in FIG. 21) of thermal paper 203c, an IC circuit part 151 configured to store information is provided integrally in this example. An antenna 152 connected to the IC circuit part 151 is formed on the surface of the back side of thermal paper 203C for transmitting and receiving information. The RFID circuit element To consists of the IC circuit part 151 and the antenna 152. Also on the back side (top left in FIG. 21) of the thermal paper 203c, the separation sheet 203a is bonded to the thermal paper 203c by the adhesive layer 203b. When affixing the completed RFID label T to a predetermined article or the like, the separation sheet 203a can be peeled off so that the RFID label T can be bonded to the article or the like by the adhesive layer 203b.

Here, a power cord 210 is connected to one side of the rear of the main body housing 202.

FIG. 22 is a sectional view of the cross-section taken along XXI-XXI′ of FIG. 21.

In FIG. 22, the tag tape 203A is wound around the winding core 203B into a roll (consist a tag tape roll). The tape roll body 300 comprises the tag tape 203A, the winding core 203B, and a tape holder 203 having the holder holding member 212, a guide member 220 and the like.

Between the holder holding member 212 and a guide member 220, a holder shaft member 240 in a substantially solid shaft shape is provided so as to be arranged in the axial direction on the inner circumference side of the above winding core 203B, and the tape holder 203 is mainly constituted by the holder holding member 212, the guide member 220, and the holder shaft member 240. On the end faces of the holder holding member 212 and the holder shaft member 240 on the side of the holder holding member 212, an insertion hole 216 with an inner diameter in which the holder positioning rod 213 can be fitted is formed. The depth of the insertion hole 216 is formed so that the tip end of the holder positioning rod 213 is substantially brought into contact with a contact bottom face (positioning reference portion) 216a, which is a bottom face of the insertion hole 216, in a state where the tape holder 203 is properly stored and arranged in the tape holder containing portion 204 (The details will be described later).

On the bottom face of the tape holder containing portion 204, a positioning recess portion 204A having a horizontally-long rectangular planar-shape is formed at a predetermined depth (e.g., about 1.5 to 3 mm) from the base end inside the support member 215, substantially orthogonal to the transport direction. In addition, a control substrate 232 having a control circuit part formed thereon for controlling to drive respective mechanisms according to instructions from external personal computers or the like is provided at the lower part of the tape holder containing portion 204.

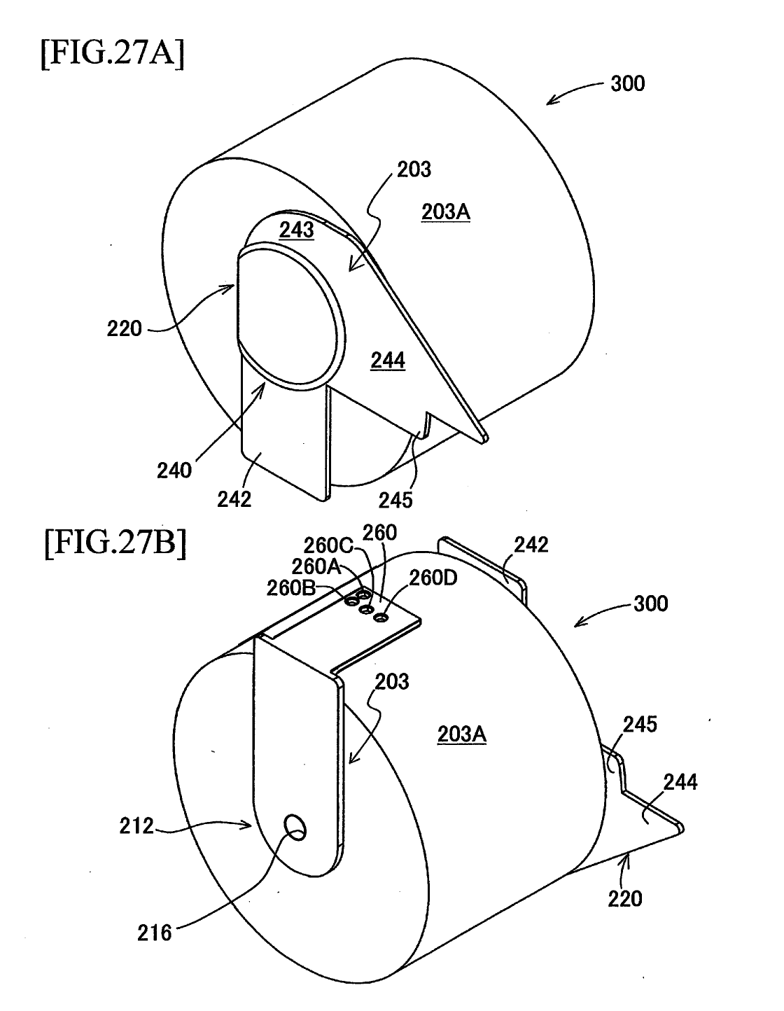

The width dimension of the positioning recess portion 204A along the transport direction is defined to be approximately equal to the width dimension of each of the lower end edges of the holder holding member 212 and the guide member 220 constituting the tape holder 203. Additionally, on the base end inside the support member 215 of the positioning recess portion 204A, a discrimination recess portion 204B is formed at a position opposing the tape discriminating portion 260 (see also FIGS. 27 to 29 described below) extending out from the lower end edge of the holder holding member 212 substantially orthogonally inward.

The discrimination recess portion 204B, having a rectangular planar-shape and being vertically-long in the transport direction, is formed at a position deeper than the positioning recess portion 204A by a predetermined depth (e.g., about 1.5 to 3 mm). In addition, the discrimination recess portion 204B has four tape discriminating sensors (tape detecting device) S1, S2, S3 and S4 provided in a substantially L-shape in this example, which comprise a push-type micro-switch and discriminate the type of the tag tape 203A. These tape discriminating sensors S1 to S4 comprise known mechanical switches, each of which is constituted by a plunger, a micro switch, and the like. The upper end of each plunger is provided so as to protrude from the bottom face of the discrimination recess portion 204B to the vicinity of the bottom face of the positioning recess portion 204A. Then, it is detected whether or not respective sensor holes (described below) of the tape discriminating portion 260 are present by each of the tape discriminating sensors S1 to S4, the ON/OFF signals of which allow detection of the type of the tag tape 203A mounted on the tape holder 203.

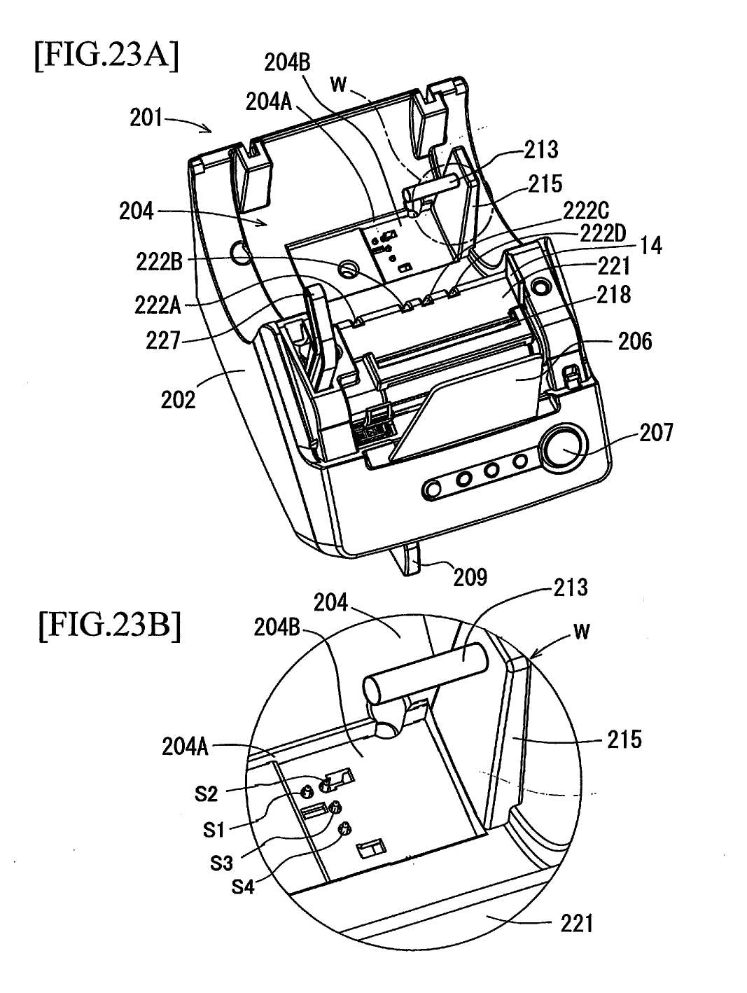

FIGS. 23A and 23B are, respectively, a perspective view illustrating the apparatus for communicating with a RFID tag shown in FIG. 19 with the upper cover 205 and the tape roll body 300 removed, and an enlarged perspective view of the portion W of FIG. 23A.

In FIGS. 23A and 23B, a mounting portion 221 configured to mount the tip of the guide member 220 constituting the tape holder 203 is provided. The mounting portion 221 is extending substantially horizontally from the back-end edge of insertion port 218 for inserting the tag tape 203A to the front upper-end edge of the tape holder containing portion 204. Here, the tip of the guide member 220 can be extended as far as the insertion port 218.

At the end edge corner portions on the rear side in the feeding direction of a mounting portion 221, four pieces of second positioning groove portions 222A to 222D with a substantially L-shaped section corresponding to the plurality of width dimensions of the tag tape 203A are formed. Each of the second positioning groove portions 222A to 222D is formed so that a part of the portion in contact with the mounting portion 221 of the guide member 220 constituting the tape holder 203 can be fitted from above. The above-mentioned positioning recess portion 204A is provided from the inner base end portion of the holder support member 215 to the position facing the second positioning groove portion 222A.

Also, the antenna 14 is provided upward at the side end edge portion on the same side as the holder support member 215 of the mounting portion 221. The antenna 14 is a directional antenna (patch antenna constituted by a micro-strip antenna, for example) equivalent to the device antenna 14 in the first embodiment and is provided with a base plate on the inner side face toward the feeding path of the tag tape 203A and with a micro-strip antenna element on the opposite outer face, having directivity in a direction toward the feeding path of the tag tape 203A.

A tag tape roll body 300 including the winding core 203B, the tag tape 203A, and the tape holder 203 is detachably attached to the tape holder containing portion 204 by fitting the holder positioning rod 213 of the holder support member 215 into the insertion hole 216 of the holder holding member 212 and the holder shaft member 240 and fitting the lower face of the tip end portion of the guide member 220 in each of the second positioning groove portions 222A to 222D so that the lower end portion of the guide member 220 is fitted and brought into contact with the recess 204A.

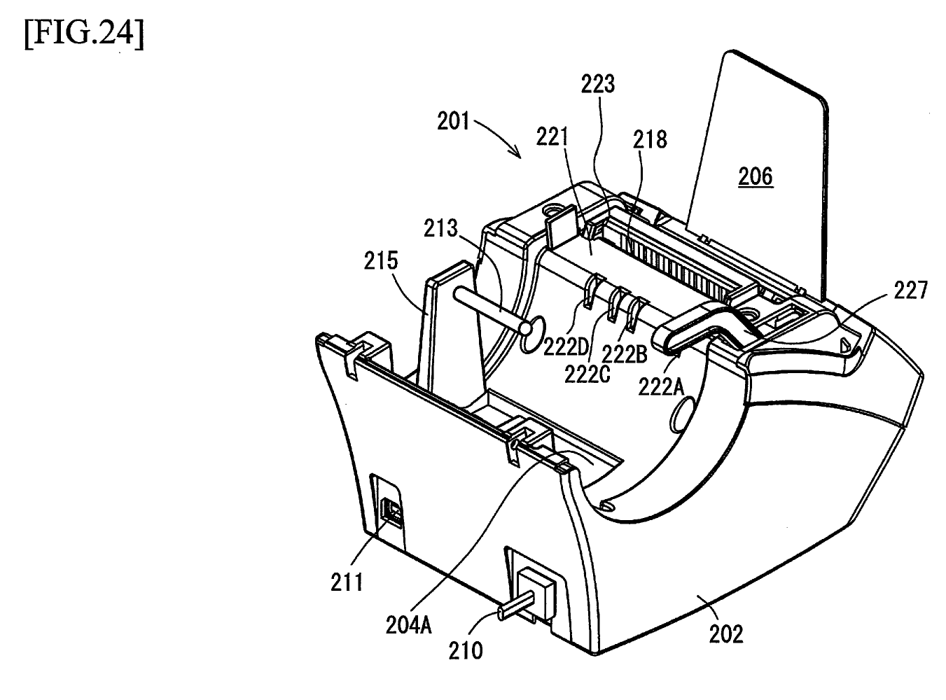

FIG. 24 is a backward perspective view illustrating the apparatus 201 for communicating with a RFID tag shown in FIG. 19 with the upper cover 205 and the tape roll body 300 removed.

In FIG. 24, a guide rib portion 223 is vertically provided on the side edge of the support member 215 of the insertion port 218. In addition, the side edge closer to the support member 215 of the insertion port 218 (left end edge in FIG. 24) is formed so that it is located at a position corresponding to the inner end face of the holder holding member 212 which is fit into the support member 215.

Here, a connector area 211 comprising a USB (Universal Serial Bus) connected to personal computers (not shown) is provided at the other side end of the back side of the body housing 202.

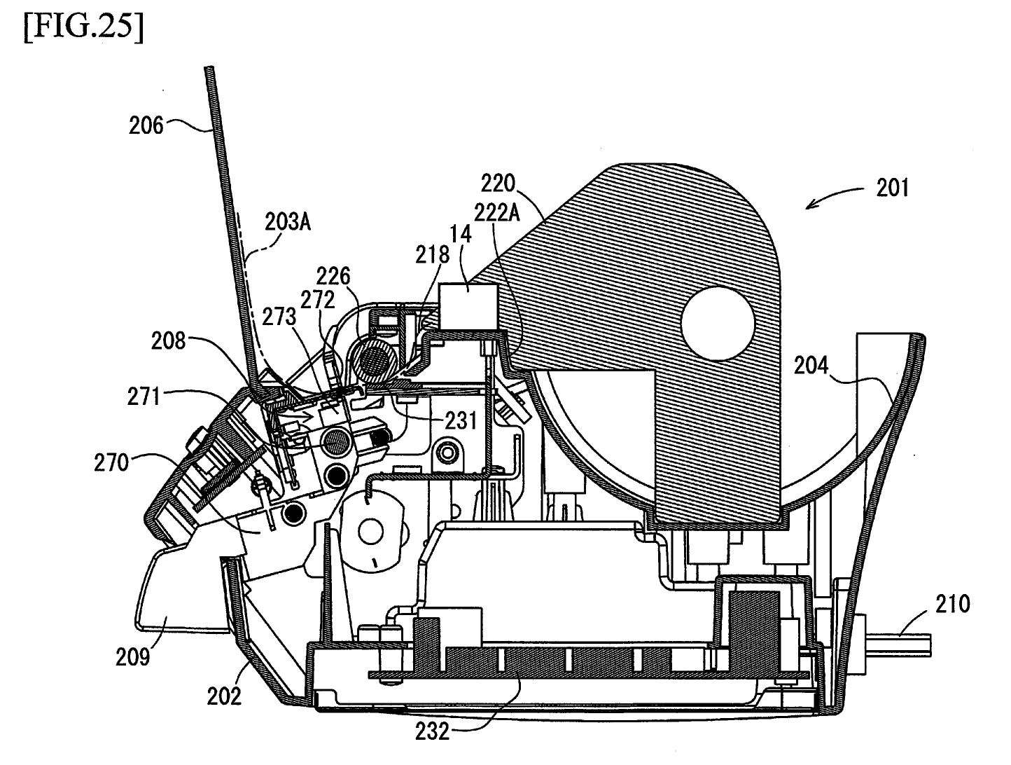

FIG. 25 is a side sectional view illustrating a state where the tape holder 203 is mounted at the apparatus 201 for communicating with a RFID tag shown in FIG. 19 with the upper cover 205 removed.

In FIG. 25, at the cutter lever 209 provided movably right and left at the side face on the front side, a cutter unit 208 moved to right and left by the cutter lever 209 is provided via a connecting member 270. The cutter unit 208 includes a cutter 272 arranged movably by a guide shaft 271 in a cutting direction (direction perpendicular to the paper surface in FIG. 25) substantially crossing the longitudinal direction of the tag tape 203A and an intermediate member 273 configured capable of engagement/disengagement with respect to the cutter 272 and provided on the side of the cutter of the connecting member 270. The cutter 272 and the intermediate member 273 constituting the cutter unit 208, the connecting member 270, the cutter lever 209, and the guide shaft 271 constitute a tape cutting device that cuts the tag tape 203A together with a trigger member 277. At the lower part of the cutter unit 208 on the upstream side (right in FIG. 25) in the feeding direction of the tape 203A, a thermal head, which is a printing means that applies print (hereinafter referred to as a print head as appropriate), 231 is provided and a platen roller 226 is provided at a position facing the head.

The print head 231 is brought into a separated state from the platen roller 226 as a result of a downward movement by lifting the above-mentioned lever 227 for operating upward or downward, and into a printable state in which the tag tape 203A is pressed and biased against the platen roller 226 as a result of an upward movement by rotating the lever 227 downward.

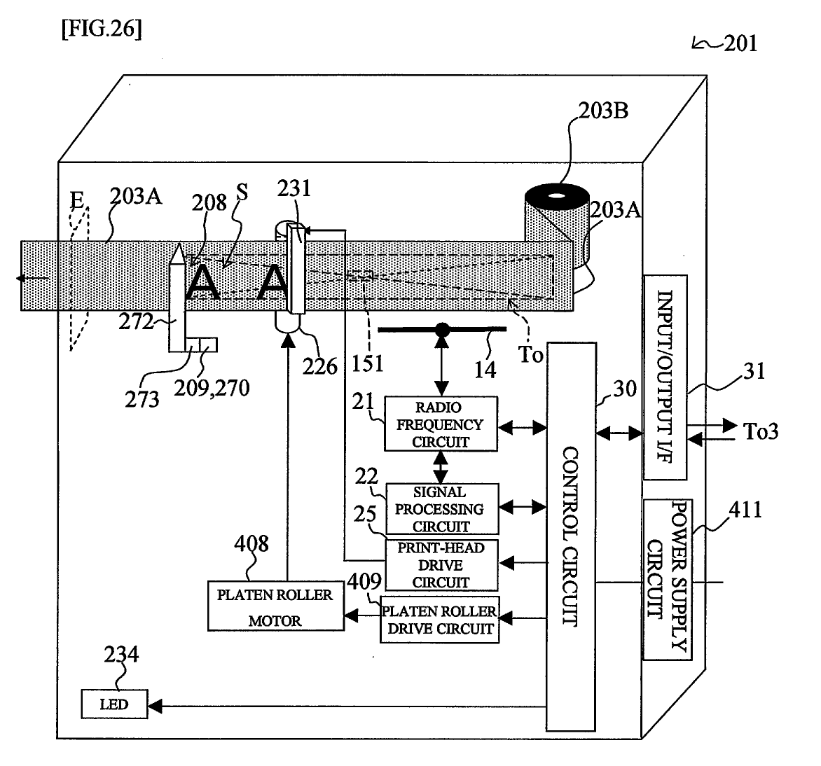

In other words, when making a print, the lever 227 is first rotated upward to cause one of the side edges of the tag tape 203A to contact the inner surface of the guide member 220 and insert the other side edge of the tag tape 203A into the insertion port 218 while causing the other side edge of the tag tape 203A to contact the guide rib portion 223 vertically provided at the side edge of the insertion port 218. By rotating the lever 227 downward in this condition, the tag tape 203A inserted through the insertion port 218 is pressed and biased toward the platen roller 226 by a line-shaped print head 231. Then predetermined print data can be sequentially printed on the print surface while transporting the tag tape 203A by controlling to drive the print head 231 while rotationally driving the platen roller 226 by a platen roller motor 408 comprising a pulse motor or a stepping motor (see FIG. 26 described below). Furthermore, access (reading or writing of information) to the IC circuit part 151 is performed via an antenna 14 located upstream side in the transport direction, and further, via an antenna 152 of the RFID circuit element To. Then, the tag tape 203A with print that is carried out onto the tray 206 is cut by the cutter unit 208 by manually operating the cutter lever 209 toward the right-side direction to produce divided RFID labels T comprising RFID circuit elements To.

FIG. 26 is a conceptual diagram illustrating a control system of the apparatus 201 for communicating with a RFID tag.

In FIG. 26, the tag tape 203A wound around the winding core 203B has a plurality of RFID circuit elements To arranged at the center part in the width direction as mentioned above, and in this example, regions corresponding to each RFID circuit element To are print regions S on which the print R corresponding to each RFID circuit element To is applied by the print head 231, and the above-mentioned printing is made after transmission/reception of a signal via radio communication by the antenna 14 using a radio frequency such as an UHF band with the RFID circuit element To provided at the tag tape 203A and the tag tape 203A on which information writing (or information reading) to the IC circuit part 151 and printing have been finished is cut at the cut unit 208 by operating the cutter lever 209 so as to produce the RFID label T.

Additionally on the apparatus 201 for communicating with a RFID tag are provided: the platen roller 226 configured to transport the tag tape 203A and the already cut RFID label T to the carry-out exit E for feed out; a radio frequency circuit 21 configured to access (read or write) information (RFID tag information) of the IC circuit part 151 of the RFID circuit element To via the antenna 14; a signal processing circuit 22 configured to receive the signal which has been read from the IC circuit part 151 of the RFID circuit element To via the radio frequency circuit 21 and perform a predetermined process to read information, as well as access the IC circuit part 151 of the RFID circuit element To via the radio frequency circuit 21; a print-head driving circuit 25 configured to control energization of the print head 231; a platen roller driving circuit 409 configured to control the platen roller motor 408 which drives the platen roller 226; a control circuit 30 configured to control the operation of the entire apparatus 201 for communicating with a RFID tag via the radio frequency circuit 21, signal processing circuit 22, the print-head driving circuit 25, the platen roller driving circuit 409 or the like; and the above-mentioned LED 234 which turns on by the control signal from the control circuit 30. Here, a feeding guide may be further provided for setting and holding the RFID circuit elements T1 in a predetermined access area opposing the antenna 14 at the timing of exchanging signals via the above-mentioned radio communication, as well as guiding each RFID label T after the cutting.

FIGS. 27A and 27B are perspective views seen from front-above and back-beneath, respectively, illustrating the detailed structure of the tape roll body 300 provided in the apparatus 201 for communicating with a RFID tag shown in FIG. 19.

In FIGS. 27A and 27B, the guide member 220 of the tape holder 203 provided in the tape roll body 300 has a first extension portion 242 inserted into the positioning recess portion 204A formed on the bottom surface of the tape holder containing portion 204 to contact the bottom surface of the positioning recess portion 204A, a second extension portion 243 extending outward so as to cover the outer end face of approximately one fourth of the circumference in the front direction of the tag tape 203A, and a third extension portion 244 extending from the outer circumference of the second extension portion 243 to nearby the insertion port 218 (see FIG. 24) of the tag tape 203A, with its upper end edge drooping down.

The lower end face of the tip of the third extension portion 244, being formed substantially horizontally, is arranged to contact the mounting portion 221 of the apparatus 201 for communicating with a RFID tag and guide one of the side edges of the tag tape 203A mounted by the inner surface of the third extension portion 244 and the second extension portion 243 to the insertion port 218. In addition, a fourth extension portion 245 is formed which extends from a position at the lower end face of the third extension portion 244 opposing the rear end edge of the mounting portion 221 in the transport direction to the first extension portion 242 by a predetermined length. The tip of the fourth extension portion 245 in the transport direction is arranged to be inserted into each of the second positioning grooves 222A-222D opposing the tape width of the mounted tag tape 203A, when the lower end face of the third extension portion 244 contacts the mounting portion 21 (see FIG. 25 described above).

The lower end edge portion of an extension portion 256 of the holder holding member 212 is extended so as to project in the lower side direction from the lower end edge portion of the guide member 220 by a predetermined length (approximately 1 to 2.5 mm in this example), and a tape discrimination portion 260 substantially in a rectangular shape extended in the inner side direction substantially at a right angle by a predetermined length is formed at the lower end edge portion.

The tape discrimination portion 260 has sensor holes 260A to 260D arranged and drilled substantially in the L-shape at predetermined positions facing each tape discriminating sensor S1 to S4 mentioned above and functions as a tag tape identification portion that identifies the type of the tag tape 203A in cooperation with the sensors S1 to S4. Moreover, the sensors S1 to S4 can also identify a print position, tape width, tape position, presence of a tag and the like as the type of the tag tape.

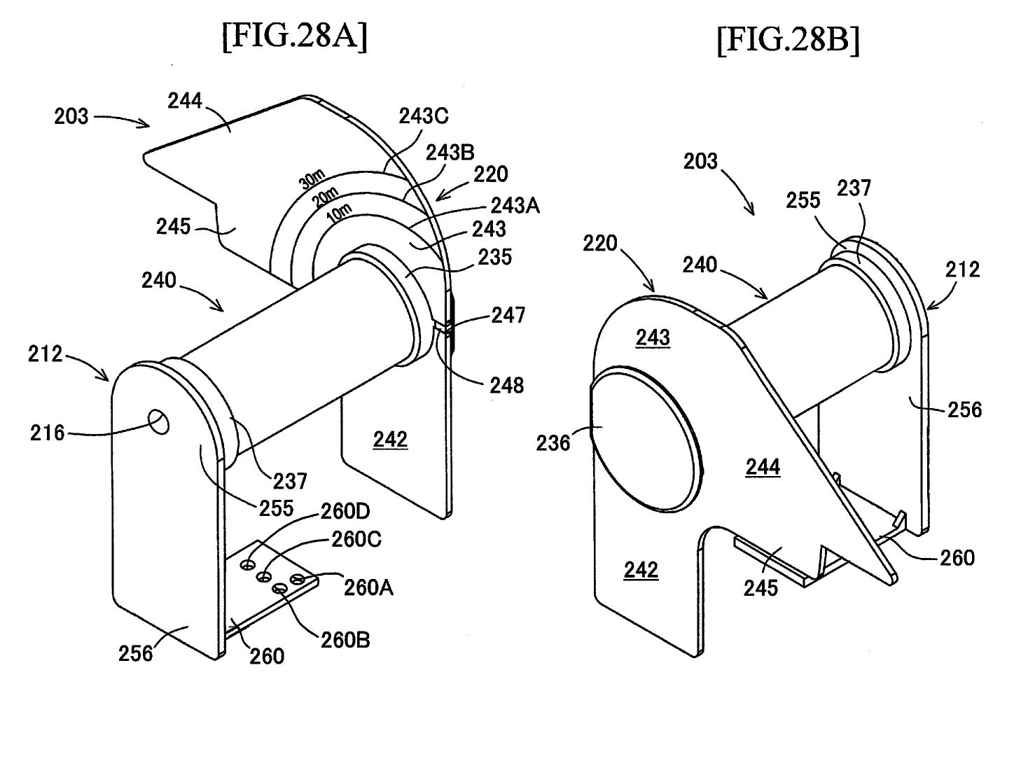

FIG. 28A is a perspective view of the tape holder, seen diagonally from the back, and FIG. 28B is a perspective view seen diagonally from the front.

In FIGS. 28A and 28B, a first cylinder portion 235 is provided at the guide member 220, and by fitting and inserting the first cylinder portion 235 in the end edge portion on one side of a cylinder hole of the winding core 203B, the guide member 220 is brought into contact with one of end faces of the tag tapes 203A. On the other hand, a second cylinder portion 237 is provided at the holder holding member 212, and by fitting and inserting the second cylinder portion 237 in the other end side of the winding core 203B, the holder holding member 212 is brought into contact with the other end face of the tag tape 203A. By the first cylinder portion 235 and the second cylinder portion 237, the winding core 203B around which the tag tape 203A is wound is rotatably held.

The holder shaft member 240 has its one end side fitted and inserted in the first cylinder portion 235 of the guide member 220, and a flange portion 236 is formed on an outer circumference portion of the end face on the one end side, the flange portion 236 being fastened to the outer end face of the first cylinder portion 235. The end portion on the other end side of the holder shaft member 240 is fitted and inserted into the second cylinder portion 237 of the holder holding member 212 and fastened to the second cylinder portion 237.

In this condition, the first extension portion 242 of the guide member 220 extends downward from the lower circumference of the outer end face of the first cylinder portion 235, with a notch 247 having a substantially square front shape provided on its the upper end, i.e., on each of the centers of both the right and left parts of the circumference of the outer end face of the first cylinder portion 235.

In addition, a set of scales 243A, 243B and 243C expressing the winding length of the mounted tag tape 203A, i.e. the remaining amount of tape 10 m, 20 m and 30 m, respectively is formed on the internal surface of respective extension portions 243, 244 and 245 of the guide member 220. Here, the maximum winding length of the tag tape 203A to be wound around the tape holder 203 is about 30 m.

At the same time, a flange portion 255 is formed on the circumference of the second cylinder portion 237 of the holder holding member 212, and also an extension portion 256 extending downward from the lower circumference of the flange portion 255 is formed. The flange portion 255 and the internal surface of the extension portion 256 contact the outer end face of the tag tape 203A and the winding core 203B.

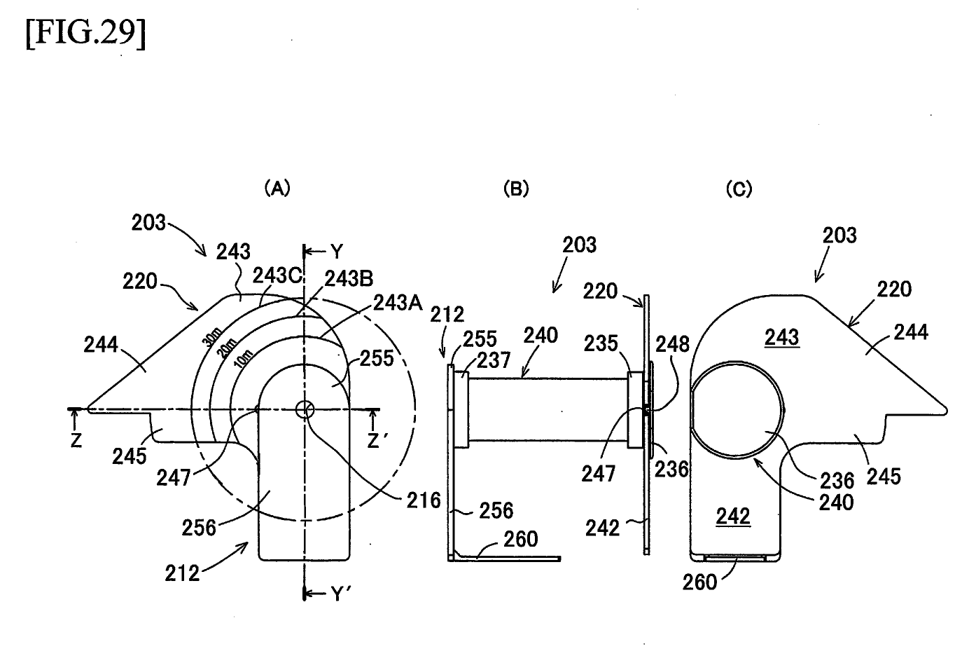

FIG. 29A is a left side view illustrating a detailed structure of the tape holder 3, FIG. 29B is a front view and FIG. 29C is a right side view.

In FIGS. 29A to 29C, as mentioned above, the holder shaft member 240 is provided between the holder holding member 212 and the guide member 220. At this time, the holder shaft member 240 is provided with a plurality of (four, for example) types of length dimensions corresponding to each length dimension of the above-mentioned winding core 203B (tape width dimension of the tag tape 203A), and by changing the length dimension of the holder shaft member 240, the plurality of types of the tape holders 203 to which the tag tape 203A with different width dimension can be attached can be easily manufactured.

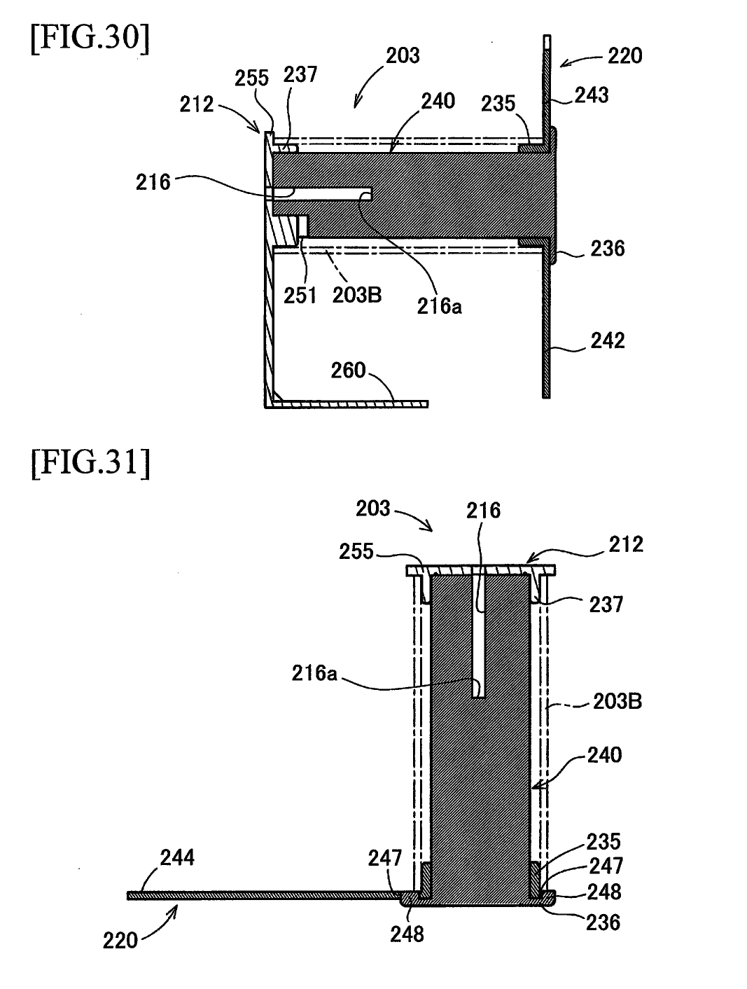

FIG. 30 is a fragmentary sectional view of the cross section taken along Y-Y′ in FIG. 29A and seen from the arrow direction.

In FIG. 30, a substantially vertically-long notch portion 251 is formed on the tip of the shaft member 240 to be inserted in the second cylinder portion 237 of the holder holding member 212. A positioning rib 250 protrudingly provided in the inner radial direction at the lower end inside the second cylinder portion 237 is inserted in the notch portion 251, whereby positioning of the holder holding member 212 and the guide member 220 can be performed according to the tape width via the shaft member 240.

FIG. 31 is a fragmentary sectional view of the cross section taken along Z-Z′ in FIG. 29A and seen from the arrow direction.

In FIG. 31, a set of positioning protrusions 248 protrudingly provided on the inner surfaces of the flange portion 236 of the shaft member 240 is inserted in the above-mentioned notch portion 247 of the first extension portion 242, whereby positioning against the guide member 220 of the shaft member 240 is performed.

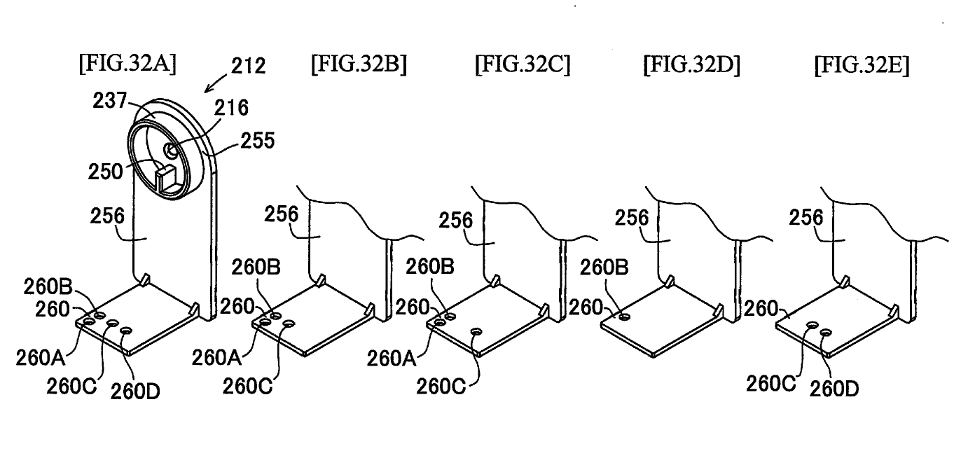

FIGS. 32A to 32E illustrate, respectively, exemplary boring of sensor holes which represent the types of the tag tape in the tape discriminating portion 260 of the holder holding member 212.

FIG. 32A illustrates an example in which four sensor holes 260A to 260D are provided on the tape discriminating portion 260, as described above. Corresponding to these tape discriminating holes 260A to 260D, the tape discriminating sensors S1 to S4 are provided in the discrimination recess portion 204B of the tape holder containing portion 204. In each of the sensors S1 to S4, its plunger projects from the bottom surface of the discrimination recess portion 204B to nearby the bottom surface of the positioning recess portion 204A, with the micro switch in the OFF state. It is then arranged that, when each of the sensor holes 260A to 260D is present at a position opposing each of the tape discriminating sensors S1 to S4, an OFF signal is output because the plunger is not pressed and the micro switch is in an OFF state, whereas an ON signal is output when each of the sensor holes 260A to 260D of the tape discriminating portion 260 is not present at a position opposing each of the tape discriminating sensors S1 to S4 because the plunger is pressed down and the micro switch is switched ON.

As thus described, the type of the tag tape 203A mounted on the tape holder 203 can be indicated by a 4-bit code (in other words, 16 types can be distinguished) by relating the detection result of whether or not the four sensor holes 260A to 260D are present to the four sensors S1 to S4 and associating the presence of individual sensor holes with “1” or “0”. FIGS. 32A to 32E each illustrate an example of the 16 types, with FIG. 32A illustrating the case in which all the sensor holes 260A, 260B, 260C and 260D are present and a detection signal “1,1,1,1” is output, FIG. 32B illustrating the case in which sensor holes 260A, 260B and 260C are present and a detection signal “1,1,1,0” is output, FIG. 32C illustrating the case in which sensor holes 260A, 260B and 260D are present and a detection signal “1,1,0,1” is output, FIG. 32D illustrating the case in which sensor hole 260B is present and a detection signal “0,1,0,0” is output, and FIG. 32E illustrating the case in which sensor holes 260C and 260D are present and a detection signal “0,0,1,1” is output.

In the manner described above, the type of the tag tape 203A mounted on the tape holder 203 can be detected by inserting the tape discriminating portion 260 provided at the lower end edge inside the positioning member 212 into the discrimination recess portion 204B and detecting the presence of the sensor holes 260A to 260D by the sensors S1 to S4.

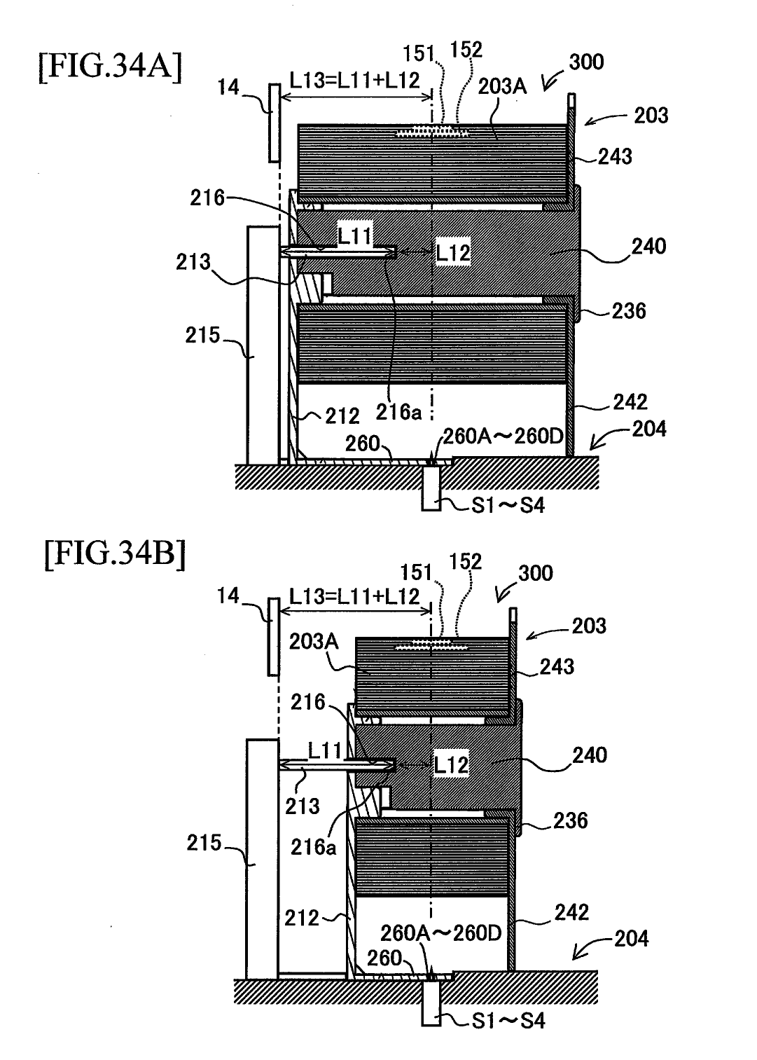

As the arrangement positions of the sensor holes 260A to 260D with respect to the side direction (axial direction of the holder shaft member 240), regardless of the type of the length dimension of the holder shaft member 240 (tape width dimension of the tag tape 203A), they are commonly arranged at the positions in substantially the same side direction as the RFID circuit elements To provided at the tag tape 203A. That is, an aggregated row of the sensor holes 260A to 260D is arranged in the direction substantially immediately below the RFID circuit element To in this example, and thus, the extended length of the tape discrimination portion 260 is different according to the type of the length dimension of the holder shaft member 240. Also, in order to correspond to the arrangement position of the aggregated row of the sensor holes 260A to 260D, an aggregated row of the tape discriminating sensors S1, S2, S3, and S4 in the discrimination recess portion 204B is also provided at the position substantially immediately below the RFID circuit element To (See FIG. 34, which will be described later).

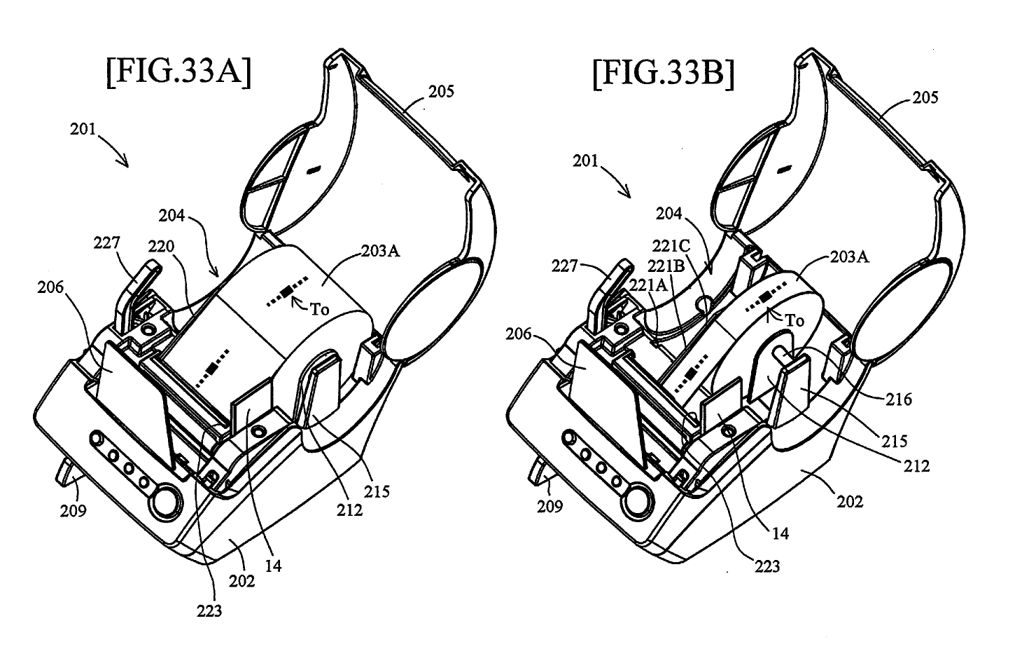

FIGS. 33A and 33B are explanatory views for illustrating an example of attachment behavior of the tape holder 203 configured as above to the side of the apparatus 201 for communicating with a RFID tag.

FIG. 33A shows an example when the tape holder 203 in which the tag tape 203A with the maximum width is wound around the winding core 203B is mounted. In FIG. 33A, first, the holder positioning rod 213 of the holder support member 215 is inserted into the insertion hole 216 in the holder holding member 212 of the tape holder 203 and then, the lower end face of the third extension portion 244 of the guide member 220 in the tape holder 203 is brought into contact onto the mounting portion 221 and the fourth extension portion 245 of the guide member 220 is fitted in the second positioning groove portion 221A formed at the corner portion on the rear side in the feeding direction of the mounting portion 221. Also, the lower end edge portion of the first extension portion 242 of the guide member 220 is fitted in and brought into contact with the positioning recess portion 204A formed at the bottom face portion of the tape holder containing portion 204.

At the same time, the tape discrimination portion 260 formed at the lower end of the extension portion 256 of the holder holding member 212 in the tape holder 203 is inserted into the discrimination recess portion 204B formed inside the base end portion of the holder support member 215.

By the above operation, the tape holder 203 is detachably attached to the tape holder containing portion 204 and presence of each opposing sensor hole 260A to 260E of the tape discrimination portion 260 can be detected via each tape discriminating sensor S1 to S4.

Subsequently, while the lever 227 is rotated upward and one of the side end edge portions of the tag tape 203A is brought into contact with the inner face of the guide member 220, the tag tape 203A is pulled out and the tag tape 203A is inserted into the insertion port 218 while the other side end edge portion is brought into contact with the guide rib portion 223 provided upright at the side end edge portion of the insertion port 218. Thereafter, by rotating the lever 227 downward, the tip end portion of the tag tape 203A is pressed by the platen roller 226 and becomes ready for print.

FIG. 33B shows an example of a case where the tape holder 203 in which the tag tape 203A with the minimum width is wound around the winding core 203B is mounted. In FIG. 33B, first, the holder positioning rod 213 of the holder support member 215 is inserted into the insertion hole 216 in the holder holding member 212 of the tape holder 203. At this time, by inserting the tip end of the holder positioning rod 213 till it is brought into contact with the contact bottom face 216a, which is the bottom face of the insertion hole 216, the arrangement position of the tape holder 203 with respect to the tape width direction of the tag tape 203A (axial direction of the holder shaft member 240 and the holder positioning rod 213) can be properly positioned (the details will be described later). Moreover, the lower end face of the third extension portion 244 of the guide member 220 in the tape holder 203 is brought into contact with the mounting portion 221 and the fourth extension portion 245 of the guide member 220 is fitted in the second positioning groove portion 221D formed at the corner portion on the rear side of the mounting portion 221 in the feeding direction. Also, the lower end edge portion of the first extension portion 242 of the guide member 220 is fitted in and brought into contact with the positioning recess portion 204A formed at the bottom face portion of the tape holder containing portion 204.

At the same time, the tape discrimination portion 260 formed at the lower end of the extension portion 256 of the holder holding member 212 in the tape holder 203 is inserted into the discrimination recess portion 204B formed inside the base end portion of the holder support member 215.

By the above operation, the tape holder 203 is detachably attached to the tape holder containing portion 204, and presence of each opposing sensor hole 260A to 260E of the tape discrimination portion 260 via each tape discriminating sensor S1 to S4 can be detected.

The subsequent rotation of the lever 227 upward is the same as above and the description will be omitted.

Also, detailed functions of the RFID circuit element To provided at the tag tape 203A and the radio frequency circuit 21 provided at the apparatus 201 for communicating with a RFID tag and appearance of the produced RFID label T are equivalent to those in the first embodiment, and illustration and description will be omitted.

The most distinctive characteristic of the apparatus 201 for communicating with a RFID tag in the second embodiment is that, first, in the tag tape roll body (the tape holder 203 and the tag tape 203A) 300, which is the container for including the RFID tag, the contact bottom face 216a in the insertion hole 216 to be the positioning reference portion is provided so that the distance between the tag antenna 152 of the tag tape 203A and the device antenna 14 provided at the apparatus 201 for communicating with a RFID tag is kept substantially constant at attachment to the apparatus 201 for communicating with RFID tag. Next, in the apparatus 201 for communicating with a RFID tag, in order to keep the distance between the device antenna 14 and the tag antenna 152 substantially constant in cooperation with the contact bottom face 216a of the tag tape roll body 300, the holder positioning rod 213 that supports the contact bottom face 216a in contact is provided. The details will be described below.

FIGS. 34A and 34B are diagrams illustrating a contact state between the holder positioning rod 213 and the contact bottom face 216a when the tag tape roll body 300 is attached to the tape holder containing portion 204 in the tag tape roll body 300 according to the present embodiment and the apparatus 201 for communicating with a RFID tag, in which FIG. 34A is a diagram illustrating a contact state of the tape roll body 300 provided with the tag tape 203A with a wide tape width and FIG. 34B is a diagram illustrating the tag tape roll body 300 provided with the tag tape 203A with a narrow tape width.

In FIGS. 34A and 34B, in the tag tape roll body 300, the width of the tape holder 203 in the side direction (axial length of the holder shaft member 240) is different according to the tape width of the tag tape 203A as mentioned above, and as compared with the tag tape roll body 300 when the tape width of the tag tape 203A is wide as shown in FIG. 34A, the tag tape roll body 300 when the tape width of the tag tape 203A is narrow as shown in FIG. 34B has a narrow width in the side direction of the tape holder 203. In a normal case, the RFID circuit element To is arranged at the center of the tag tape 203A in the tape width direction. The figure shows only the RFID circuit elements To provided at the outermost layer in the upper part of the figure in the tag tape 203A.

As mentioned above, the insertion hole 216 is drilled in the holder holding member 212 of the tape holder 203 and the holder shaft member 240 from the outer side face of the holder holding member 212, and the flat contact bottom face 216a is formed at the end portion in the depth. The respective contact bottom faces 216a of both the tag tape roll bodies 300 are commonly formed in the arrangement separated from the center position of the tag antenna 152 with the same distance L2 (second fixed value).

Then, the tip end of the holder positioning rod 213 projecting by the length L11 (third fixed value) from the inner side end face of the holder support member 215 is brought into contact with the contact bottom face 216a of the insertion hole 216 when each tag tape roll body 300 is mounted.

By this arrangement, the two tag tape roll bodies 300 are positioned by the holder positioning rod 213 so that the distance L13 as a sum of the distance L12 between the center position of the tag antenna 152 and the contact bottom face 216a and the projecting length L11 of the holder positioning rod 213 is kept constant (constant as the first fixed value, which is the sum of the second fixed value and the third fixed value), regardless of the difference in the side-direction widths in the respective tape holders 203. Also, in this example, the device antenna 14 is in the arrangement with the inner surface matching the inner-side end face of the holder support member 215 on the same plane, that is, even if the both tag tape roll bodies 300 are replaced and mounted at the same tape holder containing portion 204, the communication distance between the tag antenna 152 and the device antenna 14 can be kept constant all the time in either of them. At this time, when each tag tape roll body 300 is attached, the holder positioning rod 213 is held perpendicularly, when seen in FIGS. 34A and 34B (the distance from each tag tape roll body to the side of the holder support member 215 in the apparatus 201 for communicating with a RFID tag is constant at least in the vicinity of the antenna 14).

As mentioned above, the aggregated row of the sensor holes 260A to 260D provided at the tape discrimination portion 260 is also arranged at the position in substantially the same side direction as the RFID circuit element To (center position of the tag tape 203A in the tape-width direction) regardless of the type of the side-direction width of the tape holder 203. Therefore, when the tag tape roll body 300 is properly mounted at the tape holder containing portion 204, the aggregated row of the sensor holes 260A to 260D can be matched with the aggregated row of the tape discriminating sensors S1, S2, S3, and S4 in the discrimination recess portion 204B all the time.

In the tag tape roll body 300 and the apparatus 201 for communicating with a RFID tag of the present embodiment configured as above, when the RFID label T is to be produced, the tag tape roll body 300 containing the tag tape 203A provided with the RFID circuit element To is attached to the tape holder containing portion 204, and radio communication is performed from the device antenna 14 to the RFID circuit element To of the tag tape 203A continuously supplied from the tag tape roll body 300.

At this time, the tag tape roll body 300 of the present invention is provided with the contact bottom face 216a to be the positioning reference at the above attachment as shown in FIGS. 34A and 34B, and the apparatus 201 for communicating with a RFID tag of the present invention is provided with the holder positioning rod 213 corresponding to the contact bottom face 216a. By this arrangement, even if the various tag tape roll bodies 300 with different tag attribute parameters such as the size of the tag tape 203A, an arrangement pitch of the RFID circuit elements To and the like are replaced and used as appropriate, regardless of the type of the tag tape roll body 300, the distance between the tag antenna 152 and the device antenna 14 is kept substantially constant. By this arrangement, since the communication distance between the device antenna 14 and the tag antenna 152 is kept substantially constant all the time, a stable communication range can be obtained and assured and stable communication can be performed.

Particularly in the present embodiment, by setting the distance L12 from the contact bottom face 216a to the center position of the tag antenna 152 as the second fixed value and the distance L11 from the device antenna 14 to the tip end of the holder positioning rod 213 as the third fixed value and by setting the sum of the second fixed value and the third fixed value as the first fixed value (distance L13), the distance from the device antenna 14 to the tag antenna 152 becomes substantially equal to the first fixed value and can be kept at a substantially constant value. In the present embodiment, since the inner surface of the device antenna 14 is located on the same plane as the inner-side end face of the holder support member 215, the projecting length of the holder positioning rod 213 from the inner-side end face of the holder support member 215 is the third value, but if the inner surface of the device antenna 14 is located at an arrangement position other than that, the distance from the inner-side surface of the device antenna 14 to the tip end of the holder positioning rod 213 in the side direction becomes the third fixed value. Also, the distance L12 (second fixed value) in the side direction from the contact bottom face 216a to the center position of the tag antenna 152 may be set to zero, that is, the contact face 216a may be formed at the position in the same side direction as the center position of the tag antenna 152. In this case, the distance from the inner-side surface of the device antenna 14 to the tip end of the holder positioning rod 213 becomes the first fixed value as it is, and at attachment of the tag tape roll body 300, the tag antenna 152 is arranged at the same position in the side direction as the tip end of the holder positioning rod 213.

In the second embodiment, too, various variations are possible. The variations will be described below.

(2-1) When a plurality of types of combinations of the corresponding positioning reference portion and positioning support member is provided:

That is, in the second embodiment, only one type of combination of the contact bottom face 216a of the insertion hole 216 to be the positioning reference and the holder positioning rod 213 corresponding to the contact bottom face 216a is provided at attachment of the tag tape roll body 300, and the distance L11 from the tip end of the holder positioning rod 213 to the device antenna 14 in the side direction and the distance L12 from the contact bottom face 216a to the center position of the tag antenna 152 are respectively fixed common to all the types of the tag tape roll bodies 300. However, not limited to that, a plurality of types of combinations of the corresponding contact bottom face 216a and the holder positioning rod 213 may be provided so that contact is selectively made from the plurality of combinations according to the type of the tag tape roll body 300.

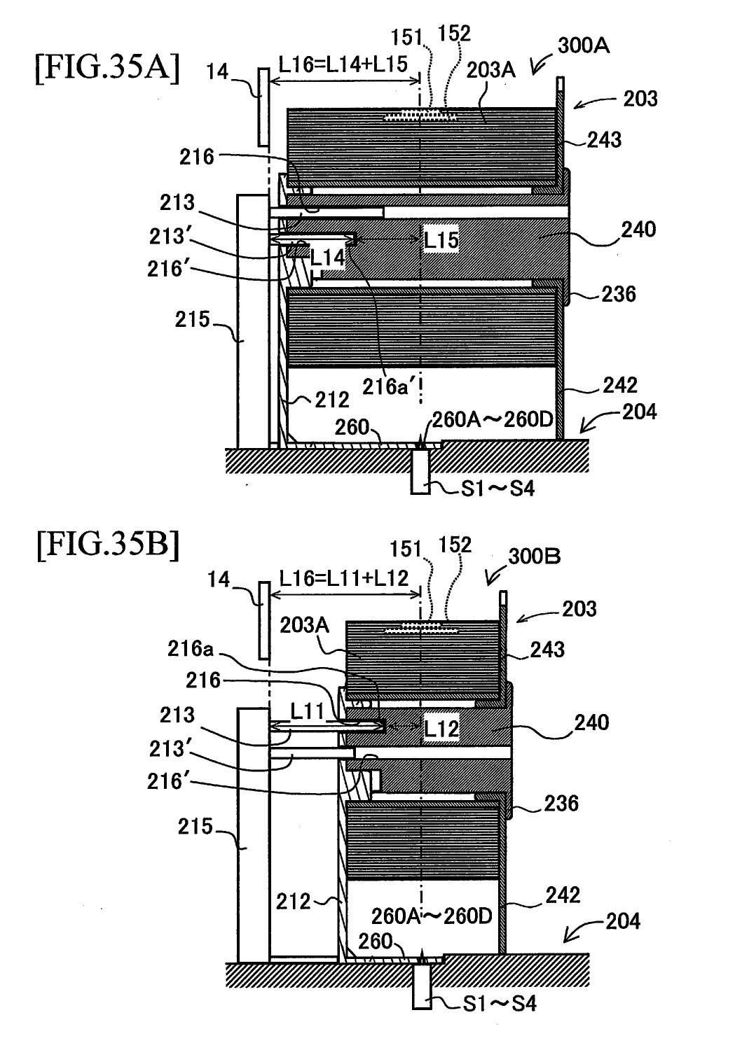

FIGS. 35A and 35B are diagrams illustrating a contact state between the holder positioning rod and the contact bottom face when the tag tape roll bodies 300A, 300B are attached to the tape holder containing portion 204 in the tag tape roll bodies 300A, 300B provided with two types of combinations of the corresponding contact bottom face and the holder positioning rod and the apparatus 201 for communicating with a RFID tag and correspond to FIGS. 34A and 34B of the second embodiment. The portions equivalent to those in the second embodiment are given the same reference numerals and the description will be omitted.

In FIGS. 35A and 35B, in the holder holding member 212 and the holder shaft member 240 in the both tag tape roll bodies 300A, 300B, two insertion holes 216, 216′ are drilled side by side in the vertical direction, respectively. In the tag tape roll body 300A shown in FIG. 35A, the upper insertion hole 216 located above is formed so as to penetrate the holder shaft member 240, while the lower insertion hole 216′ located below is formed with the depth where the lower contact bottom face 216′a, which is its bottom face, is separated from the center position of the tag antenna 152 by a distance L15. In the tag tape roll body 300B shown in FIG. 35B, the upper insertion hole 216 located above is formed with the depth where the upper contact bottom face 216a, which is its bottom face, is separated from the center position of the tag antenna 152 by the distance L12 (<distance L15), while the lower insertion hole 216′ located below is formed so as to penetrate the holder shaft member 240.

Also, in the inner-side end face of the holder support member 215 in the apparatus 201 for communicating with a RFID tag, two holder positioning rods 213, 213′ are projected side by side in the vertical direction, and the upper holder positioning rod 213 located above is formed with the projecting length L11 from the inner-side end face of the holder support member 215, while the holder positioning rod 213′ located below is formed with a projecting length L14 shorter than the upper holder positioning rod 213.

In FIG. 35A, when the tag tape roll body 300A is attached, the upper holder positioning rod 213 is inserted through the upper insertion hole 216 (through hole) without contact at the tip end, and the tip end of the lower holder positioning rod 213′ is brought into contact with the lower contact bottom face 216′a of the lower insertion hole 216′ so as to position the tag tape roll body 300A in the side direction.

In FIG. 35B, when the tag tape roll body 300B is attached, the lower holder positioning rod 213 is inserted through the lower insertion hole 216 (through hole) without contact at the tip end, and the tip end of the upper holder positioning rod 213 is brought into contact with the upper contact bottom face 216a of the upper insertion hole 216 so as to position the tag tape roll body 300B in the side direction.

Then, the sum of the distance L15 from the center position of the tag antenna 152 to the lower contact bottom face 216′a and the projecting length L14 of the lower holder positioning rod 213′ shown in FIG. 35A is equal to the sum of the distance L12 from the center position of the tag antenna 152 to the upper contact bottom face 216a and the projecting length L11 of the upper holder positioning rod 213 shown in FIG. 35B. In this example, too, the inner-side surface of the device antenna 14 is located on the same plane as the inner-side end face of the holder support member 215.

As mentioned above, in the mounted state of the both tag tape roll bodies 300A, 300B, the combination of the respective holder positioning rods 213, 213′ and the contact bottom faces 216a, 216′a to be brought into contact are different but the distance between the center position of the tag antenna 152 and the device antenna 14 can be made the same as the distance L13 (L13=L11+L12=L14+L15) and constant. That is, even if the both tag tape roll bodies 300A, 300B are replaced and mounted at the same tape holder containing portion 204, the communication distance between the tag antenna 152 and the device antenna 14 in the respective cases can be made constant all the time.

In this variation, too, the same effect as that in the second embodiment can be obtained. The combination of the contact bottom face 216a and the holder positioning rod 213 to be made to correspond may be provided more than two types as above and in that case, the insertion hole 216 other than the combination to be brought into contact should be formed as a through hole (or formed deeper than the projecting length of the corresponding holder positioning rod 213).

(2-2) Types of the device antenna

In the second embodiment, a directional antenna constituted by a micro-strip antenna is used as the antenna provided at the apparatus for communicating with a RFID tag, but not limited to that, a dipole antenna provided with a substantially linear antenna element may be used. In this variation, too, communication with the RFID circuit element of the tag tape for information writing or reading is possible and the same effect as that of the second embodiment can be obtained. Also, the apparatus can be constructed smaller.

In the above two embodiments and their variations, the case where the RFID circuit elements To are arranged at the center position of the tag medium (base tape 101, tag tape 203A) in the width direction was described, but the present invention can be applied to a case where the RFID circuit elements To are arranged at a position other than the center position in the width direction (biased position in the width direction) and a case where the positions in the width direction of the RFID circuit elements To are different according to the type of the container for including RFID tag (cartridge 100, tag tape roll body 300). That is, in those cases, too, by setting the distance between the center position of the RFID circuit element To and the positioning reference portion (rib contact face 91a, contact bottom face 216a) similarly to the embodiments and the variations, the distance between the device antenna 14 and the tag antenna 152 can be kept substantially constant.

In the above, a case where a roll is configured with a tag tape wound around it, the roll is arranged in the cartridge and the tag tape is fed out was described, but not limited to that. For example, it may be so configured that a lengthy flat-paper state or strip-state tapes or sheets (including those formed by feeding out the tape wound around the roll and then, by cutting it to an appropriate length) on which at least one RFID circuit element To is arranged are stacked in a predetermined storage portion to obtain a cartridge, the cartridge is mounted at the cartridge holder on the side of the apparatus for communicating with a RFID tag and transferred and fed from the storage portion, and the print and writing are applied so as to produce the tag labels.

Moreover, not limited even to the cartridge type, configuration to mount the roll directly to the side of the apparatus for communicating with a RFID tag or configuration in which the lengthy flat-paper state or strip-state tapes or sheets are transferred one by one from outside the apparatus for communicating with a RFID tag by a predetermined feeder mechanism and supplied into the apparatus for communicating with a RFID tag are possible. In these cases, too, the same effect as above can be obtained.

Also, the above variations can be configured by combining them as appropriate regardless of distinction between the embodiments.

The “Scroll All ID” signal, the “Erase” signal, the “Verify” signal, the “Program” signal, the “Kill” signal, and the “Sleep” signal used in the above shall comply with the specification formulated by EPC global. The EPC global is a non-profit corporation jointly established by International EAN Association, which is an international organization of distribution codes, and UCC (Uniformed Code Council), which is a U.S. distribution code organization. Signals complying with other standards will do as long as they serve the same functions.

Though not specifically exemplified, the present invention should be put into practice with various changes made in a range not departing from its gist.

What is claimed is:

1. A container for including RFID tag configured to be detachably attached to an apparatus for communicating with a RFID tag, comprising:
a tag medium in which a RFID circuit element provided with an IC circuit part that stores information and a tag antenna connected to said IC circuit part is arranged and contained capable of continuous supply to said apparatus for communicating with a RFID tag; and
a positioning-reference portion to be a positioning reference so that a distance between said tag antenna of said tag medium and a device antenna provided at said apparatus for communicating with a RFID tag is kept substantially constant regardless of a size of said container for including RFID tag at attachment of said apparatus for communicating with a RFID tag.

2. A container for including RFID tag according to claim 1, wherein:
said positioning-reference portion is configured in cooperation with a positioning-support member of said apparatus for communicating with a RFID tag provided that supports said positioning-reference portion in contact so that a sum of a distance from said positioning-reference portion to a center position of said tag antenna and a distance from said positioning-support member to said device antenna is a predetermined first fixed value.

3. A container for including RFID tag according to claim 2, wherein:
said positioning-reference portion is configured so that said distance to said center position of said tag antenna is a predetermined second fixed value.

4. A container for including RFID tag according to claim 1, wherein:
said tag medium is a tag tape on which a plurality of said RFID circuit elements is continuously arranged in the longitudinal direction; and
said container for including RFID tag contains a tag tape roll around which said tag tape is wound, and is configured to be detachably attached to a cartridge holder of said apparatus for communicating with a RFID tag.

5. A container for including RFID tag according to claim 1, wherein:
said positioning-reference portion functions as a positioning reference that keeps a distance to the side of said apparatus for communicating with a RFID tag in a direction perpendicular to the feeding direction of said tag medium substantially constant in a predetermined feeding range at attachment of said apparatus for communicating with a RFID tag.

6. An apparatus for communicating with a RFID tag comprising:
a holder for installing a container in which a container for including RFID tag having a tag medium with a RFID circuit element provided with an IC circuit part that stores information and a tag antenna connected to said IC circuit part arranged and contained capable of continuous supply and a positioning-reference portion to be a positioning reference at attachment to said apparatus for communicating with a RFID tag is detachably installed;
a device antenna for transmission/reception of information with said IC circuit part of said RFID circuit element via radio communication; and
a positioning-support member configured to support said positioning-reference portion in contact so as to keep a distance between said device antenna and said tag antenna substantially constant in cooperation with said positioning-reference portion of said container for including a RFID tag.

7. An apparatus for communicating with a RFID tag according to claim 6, wherein:
said positioning-support member is configured so that a sum of a distance from said positioning-support member to said device antenna and a distance from said positioning-reference portion to a center position of said tag antenna is a predetermined first fixed value in cooperation with said positioning-reference portion of said container for including RFID tag.

8. An apparatus for communicating with a RFID tag according to claim 7, wherein:
in correspondence with configuration that a distance from said positioning-reference portion of said container for including RFID tag to said center position of said tag antenna is a predetermined second fixed value, said positioning-support member is configured so that a distance from its distal end to said device antenna is a predetermined third fixed value.

9. An apparatus for communicating with a RFID tag according to claim 6, further comprising a printing device configured to perform a print on said tag medium fed out from said container for including RFID tag.

10. An apparatus for communicating with a RFID tag according to claim 9, wherein:
said positioning-support member supports said positioning-reference portion in contact so as to keep a distance to said container for including RFID tag in a direction perpendicular to the feeding direction of said tag medium substantially constant in a predetermined feeding range when said container for including RFID tag is attached to said holder for installing a container.

11. An apparatus for communicating with a RFID tag according to claim 6, wherein:
said holder for installing a container is a cartridge holder in which a cartridge for including a RFID tag containing a tag tape roll around which a tag tape with a plurality of said RFID circuit elements continuously arranged in the longitudinal direction as said tag medium can be detachably attached.

12. An apparatus for communicating with a RFID tag according to claim 11, wherein:
said positioning-support member is a projection portion provided at said cartridge holder.

13. An apparatus for communicating with a RFID tag according to claim 6, wherein:
said device antenna is a micro-strip antenna provided with a micro-strip antenna element on one side and a base plate on the other side.

14. An apparatus for communicating with a RFID tag according to claim 6, wherein:
said device antenna is a dipole antenna provided with a substantially linear antenna element.
